(19) United States
(12) Patent Application Publication
(10) Pub. No.: US 2023/0225420 A1
(43) Pub. Date: Jul. 20, 2023

(54) AEROSOL GENERATING DEVICE

(71) Applicant: Nicoventures Trading Limited, London (GB)

(72) Inventors: Benjamin Zainuddin, London (GB); Sylwia Kuzmicka, London (GB); Divya Kumaran Sivaretnam, London (GB); Pablo Javier Ballesteros Gomez, London (GB)

(21) Appl. No.: 18/001,585

(22) PCT Filed: Jun. 14, 2021
(86) PCT No.: PCT/EP2021/065946

§ 371 Date: Dec. 12, 2022

(30) Foreign Application Priority Data
Jun. 13, 2020 (GB) 2009015.5
Sep. 16, 2020 (GB) 2014615.5

(51) Int. Cl. A24F 40/57; A24F 40/465; A24F 40/51; H05B 6/10; A24F 40/10

(52) U.S. Cl. CPC A24F 40/57; A24F 40/465; A24F 40/51; H05B 6/105; A24F 40/10; A24F 40/60

(57) ABSTRACT

An aerosol generating device for generating aerosol from an aerosol generating material is disclosed. The aerosol generating device includes a first heating unit and a second heating unit both arranged to heat, but not burn, an aerosol generating material in use. A controller is arranged to control the first and second heating units wherein during the course of a session the controller is arranged to set the first heating unit: (i) a target operating temperature T1 during a time period t1-t2; (ii) a target operating temperature T2 during a time period t2-t3; (iii) a target operating temperature T3 during a time period t3-t6; and (iv) a target operating temperature T4 during a time period t6-t7; wherein temperature T1>T2>T3>T4 and time t0<t1<t2<t3<t4<t5<t6<t7.

### PRIORITY CLAIM

The present application is a US National Phase of PCT/EP2021/065946, filed Jun. 14, 2021, which claims the benefit of Great Britain Application No. 2009015.5, dated Jun. 13, 2020 and Great Britain Application No. 2014615.5, dated Sep. 16, 2020, the disclosures of which are incorporated herein by reference.

### TECHNICAL FIELD

The present disclosure relates to an aerosol generating device, a method of generating an aerosol using the aerosol generating device, an aerosol generating system comprising the aerosol generating device and use of an aerosol generating device.

### BACKGROUND

Articles such as cigarettes, cigars and the like burn tobacco during use to create tobacco smoke. Attempts have been made to provide alternatives to these types of articles, which burn tobacco, by creating products that release compounds without burning. Apparatus is known that heats smokable material to volatilise at least one component of the smokable material, typically to form an aerosol which can be inhaled, without burning or combusting the smokable material. Such apparatus is sometimes described as a “heat-not-burn” apparatus or a “tobacco heating product” (THP) or “tobacco heating device” or similar. Various different arrangements for volatilising at least one component of the smokable material are known.

The material may be for example tobacco or other non-tobacco products or a combination, such as a blended mix, which may or may not contain nicotine.

It is desired to provide an improved aerosol generating device.

### SUMMARY

At its most general, there is provided an aerosol generating device which heats up rapidly to provide an improved user experience.

According to an aspect there is provided an aerosol generating device for generating aerosol from an aerosol generating material comprising:

a first heating unit arranged to heat, but not burn, an aerosol generating material in use;

a second heating unit arranged to heat, but not burn, the aerosol generating material in use; and

a controller arranged to control the first and second heating units wherein during the course of a session the controller is arranged to set the first heating unit:

(i) a target operating temperature T1 during a time period t1-t2;

(ii) a target operating temperature T2 during a time period t2-t3;

(iii) a target operating temperature T3 during a time period t3-t6; and

(iv) a target operating temperature T4 during a time period t6-t7;

wherein temperature T1>T2>T3>T4 and time t0<t1<t2<t3<t4<t5<t6<t7.

According to an embodiment during the course of a session the controller is further arranged to set the second heating unit:

(i) a target operating temperature T5 during a time period t0-t4;

(ii) a target operating temperature T6 during a time period t4-t5; and

(iii) a target operating temperature T7 during a time period t5-t7;

wherein temperature T7>T6>T5.

According to an embodiment t0=0 s and comprises the start of the session.

According to an embodiment t1=2±2 s.

According to an embodiment t2=20±10 s and comprises time of first puff.

According to an embodiment t3=65±10 s.

According to an embodiment t4=82±10 s.

According to an embodiment t5=170±10 s.

According to an embodiment t6=185±10 s.

According to an embodiment t7=260±10 s and comprises the end of the session.

According to an embodiment T1=285° C.±10° C.

According to an embodiment T2=270° C.±10° C.

According to an embodiment T3=250° C.±10° C.

According to an embodiment T4=220° C.±10° C.

According to an embodiment T5=ambient or <100° C.

According to an embodiment T6=160° C.±10° C.

According to an embodiment T7=250° C.±10° C.

In some embodiments, the aerosol generating device may be configured such that at the first heating unit reaches a maximum temperature within approximately 15 seconds of supplying power to the first heating unit, or 12 seconds, or 10 seconds, or 5 seconds, or 2 seconds. In an embodiment the first heating unit comprises an induction heating unit. In an embodiment, the aerosol generating device is configured such that the first heating unit reaches a maximum temperature within approximately 2 seconds of supplying power to the heating unit. In a particular embodiment, the aerosol generating device is a tobacco heating product, and the aerosol generating device is configured such that the first heating unit reaches a maximum temperature within approximately 12 seconds of supplying power to the first heating unit, or 10 seconds, or 5 seconds, or 2 seconds.

The device may be activated by a user interacting with the device. In some embodiments, the aerosol generating device may be configured such that the first heating unit reaches a maximum temperature within approximately 15 seconds of activating the device, or 12 seconds, or 10 seconds, or 5 seconds, or 2 seconds. In an embodiment, the device is configured such that the device reaches a maximum temperature within approximately 2 seconds of activation. In a particular embodiment, the aerosol generating device is a tobacco heating product, and the heating assembly is configured such that the first induction heating unit reaches a maximum temperature within approximately 12 seconds of activating the device, or 10 seconds, or 5 seconds, or 2 seconds.

In some embodiments, the first heating unit is controllable independent from the second heating unit. In particular embodiments, the device may be configured such that the first heating unit reaches a maximum operating temperature within approximately 20 seconds of activating the device, and the second heating unit reaches a maximum operating temperature at a later stage.

The first and the second heating units may comprise induction heating units. However, it is not essential that both the first and the second heating units comprise induction heating units.

According to various embodiments either: (i) the first heating unit comprises an induction heating unit and the second heating unit comprises an induction heating unit; (ii) the first heating unit comprises an induction heating unit and the second heating unit comprises a resistive or non-induction heating unit; (iii) the first heating unit comprises a resistive or non-induction heating unit and the second heating unit comprises an induction heating unit; or (iv) the first heating unit comprises a resistive or non-induction heating unit and the second heating unit comprises a resistive or non-induction heating unit.

In some embodiments the device may be configured such that the second heating unit reaches a maximum operating temperature after at least approximately 30 seconds, 40 seconds, 50 seconds, 60 seconds, 80 seconds, 100 seconds, or 120 seconds from the start of a session of use. Optionally, the device is arranged such that the second heating unit reaches a maximum operating temperature after at least approximately 120 seconds from the start of the session of use.

In some embodiments, the device is configured such that the second heating unit reaches a maximum operating temperature at least approximately 10 seconds, 20 seconds, 30 seconds, 40 seconds, 50 seconds, 60 seconds, 80 seconds, 100 seconds, or 120 seconds after the first heating unit reaches its maximum operating temperature. Optionally, the device is configured such that the second heating unit reaches a maximum operating temperature at least approximately 120 seconds after the first heating unit reaches its maximum operating temperature.
In some embodiments, the device is configured such that the second heating unit rises to a first operating temperature which is lower than the maximum operating temperature before subsequently rising to its maximum operating temperature. The device is configured such that the second heating unit reaches a first operating temperature lower than the maximum operating temperature at least approximately 10 seconds, 20 seconds, 30 seconds, 40 seconds, 50 seconds, or 60 seconds after the start of the session of use.

In some embodiments, the device is configured such that the second induction heating unit rises from a first operating temperature which is lower than the maximum operating temperature to its maximum operating temperature within 10 seconds, or 5 seconds, 4 seconds, 3 seconds or 2 seconds of the programmed time point for increasing the temperature of the second induction heating unit to its maximum operating temperature.

In some embodiments, the maximum operating temperature of the first and/or second heating unit is from approximately 200° C. to 300° C., or 220° C. to 280° C., or 230° C. to 270° C., or 240 to 260° C., or optionally approximately 250° C. In some embodiments, the maximum operating temperature is less than approximately 300° C., or 290° C., or 280° C., or 270° C., or 260° C., or 250° C. In some embodiments, the maximum operating temperature is greater than approximately 200° C., or 210° C., or 220° C., or 230° C., or 240° C. The maximum operating temperature of the first and/or second heating unit may be selected to rapidly heat an aerosol generating material such as tobacco without burning or charring the aerosol generating material or any protective wrapper associated with the aerosol generating material (such as a paper wrap).

In some embodiments, the aerosol generating device is configured to generate aerosol from a liquid aerosol generating material. In some embodiments, the aerosol generating device is configured to generate aerosol from a combination of liquid and non-liquid aerosol generating material. In other, embodiments, the aerosol generating device is configured to generate aerosol from a non-liquid aerosol generating material.

The aerosol generating material may comprise tobacco and/or tobacco extract. In a particular embodiment, the aerosol generating material comprises solid tobacco. The aerosol generating material may also comprise an aerosol generating agent such a glycerol. In a more embodiment, the aerosol generating device is a tobacco heating product which is configured to generate an aerosol from a non-liquid aerosol generating material comprising tobacco and optionally aerosol generating agent.

In some embodiments the aerosol generating device comprises an indicator for indicating to a user that the device is ready for use within 20 seconds of activating the device. The indicator may be configured to indicate to a user that the device is ready for use by visual and/or haptic feedback. The indicator allows a user to be confident in receiving a satisfactory first puff when using the device.

According to an aspect there is provided an aerosol generating device for generating aerosol from an aerosol generating material comprising:

a first heating unit arranged to heat, but not burn, an aerosol generating material in use;

a second heating unit arranged to heat, but not burn, the aerosol generating material in use; and

a controller arranged to control the first and second heating units wherein during the course of a session the controller is arranged to set the second heating unit:

(i) a target operating temperature T1 during a time period t0-t3;

(ii) a target operating temperature T2 during a time period t3-t4;

(iii) a target operating temperature T3 during a time period t4-t5; and

(iv) a target operating temperature T4 during a time period t5-t7;

wherein temperature T4>T3>T2>T1 and time t0<t1<t2<t3<t4<t5<t6<t7.

According to an embodiment during the course of a session the controller is further arranged to set the first heating unit:

(i) a target operating temperature T5 during a time period t1-t5; and

(ii) a target operating temperature T6 during a time period t5-t8;

wherein temperature T4>T5=T3>T6>T2>T1.

According to an embodiment t0=0 s and comprises the start of the session.

According to an embodiment t1=2±2 s.

According to an embodiment t2=15±10 s and comprises time of first puff.

According to an embodiment t3=60±10 s.

According to an embodiment t4=100±10 s.

According to an embodiment t5=130±10 s.

According to an embodiment t6=140±10 s.

According to an embodiment t7=225±10 s and comprises the end of the session.

According to an embodiment T1=ambient or <100° C.

According to an embodiment T2=140° C.±10° C.

According to an embodiment T3=260° C.±10° C.

According to an embodiment T4=270° C.±10° C.

According to an embodiment T5=260° C.±10° C.

According to an embodiment T6=230° C.±10° C.

In some embodiments, the heating assembly may be configured such that in a session of use the second induction heating unit rises from a first operating temperature which is lower than its maximum operating temperature to the maximum operating temperature at a rate of at least 50° C. per second. In an embodiment, the heating assembly is configured such that in a session of use the second induction heating unit reaches the maximum operating temperature at a rate of at least 100° C. per second. In a particular embodiment, the heating assembly is configured such that in a session of use the second induction heating unit reaches the maximum operating temperature at a rate of at least 150° C. per second.

One or more of the heating units may comprise a coil.

The heating assembly may be configured such that the first heating unit reaches a maximum operating temperature within 10 seconds, 8 seconds, 6 seconds, or 4 seconds of supplying power to the first heating unit. In one embodiment, the first heating unit is an electrically resistive heating element. For example, where the heating unit comprises a coil, the heating unit may be an induction heating unit comprising a susceptor, wherein the coil is configured to be an inductor element for supplying a varying magnetic field to the susceptor. In another embodiment, the first heating unit is an induction heating unit.

According to an aspect there is provided an aerosol generating device for generating aerosol from an aerosol generating material comprising:

a first heating unit arranged to heat, but not burn, an aerosol generating material in use;

a second heating unit arranged to heat, but not burn, the aerosol generating material in use; and

a controller arranged to control the first and second heating units wherein during the course of a session the controller is arranged to set the first heating unit:

(i) a target operating temperature T1 during a time period t0-t5;

(ii) a target operating temperature T2 during a time period t5-t6;

and wherein during the course of a session the controller is further arranged to set the second heating unit:

(iii) a target operating temperature T3 during a time period t043;

(iv) a target operating temperature T4 during a time period t3-t4; and

(v) a target operating temperature T5 during a time period t4-t6;

wherein temperature T1>T5>T2>T4>T3 and time t0<t1<t2<t3<t4<t5<t6.

According to an embodiment t0=0 s and comprises the start of the session.

According to an embodiment t1=2±2 s.

According to an embodiment t2=15±10 s and comprises time of first puff.

According to an embodiment t3=64±10 s.

According to an embodiment t4=79±10 s.

According to an embodiment t5=85±10 s.

According to an embodiment t6=195±10 s and comprises the end of the session.

According to an embodiment T1=280° C.±10° C.

According to an embodiment T2=220° C.±10° C.

According to an embodiment T3=ambient or <100° C.

According to an embodiment T4=160° C.±10° C.

According to an embodiment T5=260° C.±10° C.

The aerosol generating device optionally has a mouth end and a distal end, wherein the first heating unit may be arranged closer to the mouth end of the aerosol generating device than the second heating unit.

The first heating unit may be controllable independent from the second heating unit.

The device may be configured such that the first and second heating units have temperature profiles which differ from each other in use.

The device may be configured such that in use the second unit rises from a first operating temperature to a maximum operating temperature which is higher than the first operating temperature at a rate of at least 50° C. per second.

The device may be configured such that the first heating unit reaches a maximum operating temperature within 2 seconds of activating the device.

The aerosol generating device may be configured to generate aerosol from a non-liquid aerosol generating material.

The non-liquid aerosol generating material may comprise tobacco.

The aerosol generating device may be a tobacco heating product.

The device may further comprise an indicator for indicating to a user that the device is ready for use within 20 seconds of activating the device.

The maximum operating temperature of the first heating unit may be in the range 200-300° C. and/or the maximum operating temperature of the second heating unit may be in the range 200-300° C.

According to further embodiments the device may comprise a third or further heating unit.

According to another aspect there is provided a method of generating aerosol from an aerosol generating material using an aerosol generating device as described above, the method comprising supplying power to at least one heating unit such that the at least one heating unit reaches its maximum operating temperature within 20 seconds of supplying the power to the at least one heating unit.

According to another aspect there is provided an aerosol generating system comprising an aerosol generating device as described above in combination with an aerosol generating article.

According to another aspect there is provided the use of an aerosol generating device as described above.

In some embodiments, the device is configured such that the at least one heating unit reaches a temperature of from 200° C. to 280° C. within 20 seconds and substantially maintains that temperature (that is, within 10° C., 5° C., 4° C., 3° C., 2° C. or 1° C. of that temperature) for 2 seconds, 3 seconds, 4 seconds, 5 seconds, 10 seconds, 15 seconds, 20 seconds, or 30 seconds.

In some embodiments, the desired operating temperature is reached within 15 seconds of supplying power to the first heating unit, or 12 seconds, or 10 seconds, or 5 seconds, or 2 seconds.

In some embodiments, the first and/or second heating unit reaches a temperature of from 200° C. to 300° C., or 200° C. to 280° C., or 210° C. to 270° C., or 210° C. to 260° C., or 210° C. to 250° C. In some embodiments, the first and/or second heating unit reaches a temperature of less than approximately 300° C., or 290° C., or 280° C., or 270° C., or 260° C., or 250° C. In some embodiments, the first and/or second heating unit reaches a temperature of greater than approximately 200° C., or 210° C., or 220° C., or 230° C., or 240° C.

According to an aspect there is provided an aerosol generating device for generating aerosol from an aerosol generating material comprising:

a first heating unit arranged to heat, but not burn, an aerosol generating material in use; and

a controller arranged to control the first heating unit wherein during the course of a session the controller is arranged to set the first heating unit a target operating temperature which progressively reduces in four or more different stages or steps.

The device may further comprise a second heating unit arranged to heat, but not burn, the aerosol generating material in use and wherein the controller is further arranged set the second heating unit one more target operating temperatures.

According to another aspect there is provided an aerosol generating device for generating aerosol from an aerosol generating material comprising:

a first heating unit arranged to heat, but not burn, an aerosol generating material in use;

a second heating unit arranged to heat, but not burn, the aerosol generating material in use; and

a controller arranged to control the first and second heating units wherein during the whole course of a session the controller limits the first heating unit to a maximum operating temperature T1 and wherein at a first point in time during the session the controller is further arranged to set the second heating unit an operating temperature(s) T2, wherein T2 is greater than T1.

According to an embodiment T2 remains greater than T1 from the first point in time until the end of the session.

According to an aspect there is provided an aerosol generating device for generating aerosol from an aerosol generating material comprising:

a first heating unit arranged to heat, but not burn, an aerosol generating material in use;

a second heating unit arranged to heat, but not burn, the aerosol generating material in use; and

a controller arranged to control the first and second heating units wherein during the course of a session the controller is arranged to set the first heating unit:

(i) a (maximum) target operating temperature T1 during a time period t1-t8;

and wherein the controller is further arranged to set the second heating unit:

(ii) a first target operating temperature during a first time period; and

(iii) a second target operating temperature T6 during a second time period which is subsequent to the first time period;

wherein the second target operating temperature T6 is greater than the first target operating temperature and wherein temperature T6>T1.

It should be understood that the target operating temperature T1 which is referred to as a maximum target operating temperature T1 is the maximum heating or operational temperature of the first heating unit. According to various embodiments the controller is arranged at a period of time to set the operating or heating temperature T6 of the second heating unit at a higher temperature than the (maximum) heating or operational temperature of the first heating unit.

It is unknown to provide a temperature profile for the first heating unit and the second heating unit wherein in the second half of the session the (maximum) operating or heating temperature (optionally 270° C.) of the second heating unit exceeds the (maximum) operating or heating temperature (optionally 260° C.) of the first heating unit. According to an embodiment the maximum operating or heating temperature of the second heating unit may be set to be 0-10° C., 10-20° C., 20-30° C., 30-40° C. or 40-50° C. higher than the maximum operating or heating temperature of the first heating unit.

During the course of a session the controller may be further arranged to set the second heating unit optionally during the first time period:

(i) a target operating temperature T2 during a time period t0-t3;

(ii) a target operating temperature T3 during a time period t3-t4;

(iii) a target operating temperature T4 during a time period t4-t5; and

(iv) a target operating temperature T5 during a time period t5-t6;

wherein optionally the first target operating temperature comprises target operating temperature T2 and/or target operating temperature T3 and/or target operating temperature T4 and/or target operating temperature T5;

and wherein optionally the controller is further arranged to set the first heating unit:

(v) a target operating temperature T7 during a time period t8-t9;

wherein temperature T1>T7>T5>T4>T3>T2 and time t0<t1<t2<t3<t4<t5<t6<t7<t8<t9.

According to an embodiment t0=0 s and comprises the start of the session.

According to an embodiment t1=2±2 s.

According to an embodiment t2=20±10 s and comprises time of first puff. Other embodiments are contemplated wherein the time of first puff is in the range <5 s, 5-10 s, 10-15 s, 15-20 s, 20-25 s or 25-30 s. For example, the time of first puff may be a time <1, 1-2 s, 2-3 s, 3-4 s, 4-5 s, 5-6 s, 6-7 s, 7-8 s, 8-9 s, 9-10 s, 10-11 s, 11-12 s, 12-13 s, 13-14 s, 14-15 s, 15-16 s, 16-17 s, 17-18 s, 18-19 s, 19-20 s, 20-21 s, 21-22 s, 22-23 s, 23-24 s, 24-25 s, 25-26 s, 26-27 s, 27-28 s, 28-29 s, 29-30 s or >30 s.

According to an embodiment t3=25±10 s.

According to an embodiment t4=50±10 s.

According to an embodiment t5=75±10 s.

According to an embodiment t6=100±10 s.

According to an embodiment t7=130±10 s.

According to an embodiment t8=135±10 s.

According to an embodiment t9=195±10 s and comprises the end of the session.

According to an embodiment T1=260° C.±10° C.

According to an embodiment T2=ambient or <100° C.

According to an embodiment T3=100° C.±10° C.

According to an embodiment T4=150° C.±10° C.

According to an embodiment T5=200° C.±10° C.

According to an embodiment T6=270° C.±10° C.

According to an embodiment T7=230° C.±10° C.

In some embodiments, the aerosol generating device may be configured such that the first heating unit reaches a maximum temperature within approximately 15 seconds of supplying power to the first heating unit, or 12 seconds, or 10 seconds, or 5 seconds, or 2 seconds. In an embodiment the first heating unit comprises an induction heating unit. In an embodiment, the aerosol generating device is configured such that the first heating unit reaches a maximum temperature within approximately 2 seconds of supplying power to the heating unit. In a particular embodiment, the aerosol generating device is a tobacco heating product, and the aerosol generating device is configured such that the first heating unit reaches a maximum temperature within approximately 12 seconds of supplying power to the first heating unit, or 10 seconds, or 5 seconds, or 2 seconds.

The device may be activated by a user interacting with the device. In some embodiments, the aerosol generating device may be configured such that the first heating unit reaches a maximum temperature within approximately 15 seconds of activating the device, or 12 seconds, or 10 seconds, or 5 seconds, or 2 seconds. In an embodiment, the device is configured such that the device reaches a maximum temperature within approximately 2 seconds of activation. In a particular embodiment, the aerosol generating device is a tobacco heating product, and the heating assembly is configured such that the first induction heating unit reaches a maximum temperature within approximately 12 seconds of activating the device, or 10 seconds, or 5 seconds, or 2 seconds.

In some embodiments, the first heating unit is controllable independent from the second heating unit. In particular embodiments, the device may be configured such that the first heating unit reaches a maximum operating temperature within approximately 20 seconds of activating the device, and the second heating unit reaches a maximum operating temperature at a later stage.

According to an embodiment both the first and the second heating units comprise induction heating units. However, it is not essential that both the first and the second heating units comprise induction heating units.

According to various embodiments either: (i) the first heating unit comprises an induction heating unit and the second heating unit comprises an induction heating unit; (ii) the first heating unit comprises an induction heating unit and the second heating unit comprises a resistive or non-induction heating unit; (iii) the first heating unit comprises a resistive or non-induction heating unit and the second heating unit comprises an induction heating unit; or (iv) the first heating unit comprises a resistive or non-induction heating unit and the second heating unit comprises a resistive or non-induction heating unit.

In some embodiments the device may be configured such that the second heating unit reaches a maximum operating temperature after at least approximately 30 seconds, 40 seconds, 50 seconds, 60 seconds, 80 seconds, 100 seconds, or 120 seconds from the start of a session of use. Optionally, the device is arranged such that the second heating unit reaches a maximum operating temperature after at least approximately 120 seconds from the start of the session of use.

In some embodiments, the device is configured such that the second heating unit reaches a maximum operating temperature at least approximately 10 seconds, 20 seconds, 30 seconds, 40 seconds, 50 seconds, 60 seconds, 80 seconds, 100 seconds, or 120 seconds after the first heating unit reaches its maximum operating temperature. Optionally, the device is configured such that the second heating unit reaches a maximum operating temperature at least approximately 120 seconds after the first heating unit reaches its maximum operating temperature.

In some embodiments, the device is configured such that the second heating unit rises to a first operating temperature which is lower than the maximum operating temperature before subsequently rising to its maximum operating temperature. The device is configured such that the second heating unit reaches a first operating temperature lower than the maximum operating temperature at least approximately 10 seconds, 20 seconds, 30 seconds, 40 seconds, 50 seconds, or 60 seconds after the start of the session of use.

In some embodiments, the device is configured such that the second induction heating unit rises from a first operating temperature which is lower than the maximum operating temperature to its maximum operating temperature within 10 seconds, or 5 seconds, 4 seconds, 3 seconds or 2 seconds of the programmed time point for increasing the temperature of the second induction heating unit to its maximum operating temperature.

In some embodiments, the maximum operating temperature of the first and/or second heating unit is from approximately 200° C. to 300° C., or 220° C. to 280° C., or 230° C. to 270° C., or 240 to 260° C., or optionally approximately 250° C. In some embodiments, the maximum operating temperature is less than approximately 300° C., or 290° C., or 280° C., or 270° C., or 260° C., or 250° C. In some embodiments, the maximum operating temperature is greater than approximately 200° C., or 210° C., or 220° C., or 230° C., or 240° C. The maximum operating temperature of the first and/or second heating unit is selected to rapidly heat an aerosol generating material such as tobacco without burning or charring the aerosol generating material or any protective wrapper associated with the aerosol generating material (such as a paper wrap).

In some embodiments, the aerosol generating device is configured to generate aerosol from a liquid aerosol generating material. In some embodiments, the aerosol generating device is configured to generate aerosol from a combination of liquid and non-liquid aerosol generating material. In other, embodiments, the aerosol generating device is configured to generate aerosol from a non-liquid aerosol generating material.

The aerosol generating material may comprise tobacco and/or tobacco extract. In a particular embodiment, the aerosol generating material comprises solid tobacco. The aerosol generating material may also comprise an aerosol generating agent such a glycerol. In a more embodiment, the aerosol generating device is a tobacco heating product which is configured to generate an aerosol from a non-liquid aerosol generating material comprising tobacco and optionally aerosol generating agent.

In some embodiments the aerosol generating device comprises an indicator for indicating to a user that the device is ready for use within 20 seconds of activating the device. The indicator may be configured to indicate to a user that the device is ready for use by visual and/or haptic feedback. The indicator allows a user to be confident in receiving a satisfactory first puff when using the device.

In some embodiments, the heating assembly may be configured such that in a session of use the second induction heating unit rises from a first operating temperature which is lower than its maximum operating temperature to the maximum operating temperature at a rate of at least 50° C. per second. In an embodiment, the heating assembly is configured such that in a session of use the second induction heating unit reaches the maximum operating temperature at a rate of at least 100° C. per second. In a particular embodiment, the heating assembly is configured such that in a session of use the second induction heating unit reaches the maximum operating temperature at a rate of at least 150° C. per second.

One or more of the heating units may comprise a coil.

The heating assembly may be configured such that the first heating unit reaches a maximum operating temperature within 10 seconds, 8 seconds, 6 seconds, or 4 seconds of supplying power to the first heating unit. In one embodiment, the first heating unit is an electrically resistive heating element. For example, where the heating unit comprises a coil, the heating unit may be an induction heating unit comprising a susceptor, wherein the coil is configured to be an inductor element for supplying a varying magnetic field to the susceptor. In another embodiment, the first heating unit is an induction heating unit.

The aerosol generating device optionally has a mouth end and a distal end, wherein the first heating unit may be arranged closer to the mouth end of the aerosol generating device than the second heating unit.

The first heating unit may be controllable independent from the second heating unit.

The device may be configured such that the first and second heating units have temperature profiles which differ from each other in use.

The device may be configured such that in use the second unit rises from a first operating temperature to a maximum operating temperature which is higher than the first operating temperature at a rate of at least 50° C. per second.

The device may be configured such that the first heating unit reaches a maximum operating temperature within 2 seconds of activating the device.

The aerosol generating device may be configured to generate aerosol from a non-liquid aerosol generating material.

The non-liquid aerosol generating material may comprise tobacco.

The aerosol generating device may be a tobacco heating product.

The device may further comprise an indicator for indicating to a user that the device is ready for use within 20 seconds of activating the device.

The maximum operating temperature of the first heating unit may be in the range 200-300° C. and/or the maximum operating temperature of the second heating unit may be in the range 200-300° C.

According to further embodiments the device may comprise a third or further heating unit.

According to another aspect there is provided a method of generating aerosol from an aerosol generating material using an aerosol generating device as described above, the method comprising supplying power to at least one heating unit such that the at least one heating unit reaches its maximum operating temperature within 20 seconds of supplying the power to the at least one heating unit.

According to another aspect there is provided an aerosol generating system comprising an aerosol generating device as described above in combination with an aerosol generating article.

According to another aspect there is provided the use of an aerosol generating device as described above.

In some embodiments, the device is configured such that the at least one heating unit reaches a temperature of from 200° C. to 280° C. within 20 seconds and substantially maintains that temperature (that is, within 10° C., 5° C., 4° C., 3° C., 2° C. or 1° C. of that temperature) for 2 seconds, 3 seconds, 4 seconds, 5 seconds, 10 seconds, 15 seconds, 20 seconds, or 30 seconds.

In some embodiments, the desired operating temperature is reached within 15 seconds of supplying power to the first heating unit, or 12 seconds, or 10 seconds, or 5 seconds, or 2 seconds.

In some embodiments, the first and/or second heating unit reaches a temperature of from 200° C. to 300° C., or 200° C. to 280° C., or 210° C. to 270° C., or 210° C. to 260° C., or 210° C. to 250° C. In some embodiments, the first and/or second heating unit reaches a temperature of less than approximately 300° C., or 290° C., or 280° C., or 270° C., or 260° C., or 250° C. In some embodiments, the first and/or second heating unit reaches a temperature of greater than approximately 200° C., or 210° C., or 220° C., or 230° C., or 240° C.

Features described herein in relation to one aspect of the invention are explicitly disclosed in combination with the other aspects, to the extent that they are compatible.

Further features and advantages of the invention will become apparent from the following description of embodiments of the invention, given by way of example only, which is made with reference to the accompanying drawings.

### BRIEF DESCRIPTION OF THE DRAWINGS

Various embodiments will now be described, by way of example only, and with reference to the accompanying drawings in which:

FIG. 1A is a schematic diagram of a heating assembly of an aerosol generating device according to an embodiment and FIG. 1B is a cross-section of the heating assembly shown in FIG. 1A with an aerosol generating article disposed therein;

FIG. 2A is a schematic cross-section of an aerosol generating article for use with the aerosol generating device according to an embodiment and FIG. 2B is a perspective view of the aerosol generating article;

FIG. 3 is a graph showing a general temperature profile of a first heating unit in an aerosol generating device according to an embodiment during an exemplary smoking session;

FIG. 4 is a graph showing a general temperature profile of a second heating unit in an aerosol generating device according to an embodiment during an exemplary smoking session;

FIG. 5 is a graph showing a general programmed heating profile of a heating element in an aerosol generating device according to an example during an exemplary session of use;

FIG. 6 is a graph showing programmed heating profiles of first and second heating units in an example according to an embodiment during a session of use, wherein the device was operated in a first (base) mode;

FIG. 7 is a graph showing programmed heating profiles of first and second heating units in an example according to an embodiment during a session of use, wherein the device was operated in a second (boost) mode;

FIG. 8 is a graph showing programmed heating profiles of first and second heating units in an example of an embodiment during a session of use, wherein the device was operated i a second (boost) mode; and

FIG. 9 is a graph showing programmed heating profiles of first and second heating units in an example of an embodiment during a session of use, wherein the device was operated in a second (boost) mode.

### DETAILED DESCRIPTION

As used herein, “the” may be used to mean “the” or “the or each” as appropriate. In particular, features described in relation to “the at least one heating unit” may be applicable to the first, second or further heating units where present. Further, features described in respect of a “first” or “second” integers may be equally applicable integers. For example, features described in respect of a “first” or “second” heating unit may be equally applicable to the other heating units in different embodiments. Similarly, features described in respect of a “first” or “second” mode of operation may be equally applicable to other configured modes of operation.

In general, reference to a “first” heating unit in the heating assembly does not indicate that the heating assembly contains more than one heating unit, unless otherwise specified; rather, the heating assembly comprising a “first” heating unit must simply comprise at least one heating unit. Accordingly, a heating assembly containing only one heating unit expressly falls within the definition of a heating assembly comprising a “first” heating unit.

Similarly, reference to a “first” and “second” heating unit in the heating assembly does not necessarily indicate that the heating assembly contains two heating units only; further heating units may be present. Rather, in this example, the heating assembly must simply comprise at least a first and a second heating unit.

Where reference is made to an event such as reaching a maximum operating temperature occurring “within” a given period, the event may occur at any time between the beginning and the end of the period.

As used herein, the term “aerosol generating material” includes materials that provide volatilised components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”. In an embodiment, the aerosol generating material is a non-liquid aerosol generating material. In a particular embodiment, the non-liquid aerosol generating material comprises tobacco.

Apparatus is known that heats aerosol generating material to volatilise at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product”, a “tobacco heating product device”, a “tobacco heating device” or similar. In an embodiment the aerosol generating device is a tobacco heating product. The non-liquid aerosol generating material for use with a tobacco heating product comprises tobacco.

Similarly, there are also so-called e-cigarette devices, which are typically aerosol generating devices which vaporise an aerosol generating material in the form of a liquid, which may or may not contain nicotine. The aerosol generating material may be in the form of or be provided as part of a rod, cartridge or cassette or the like which can be inserted into the apparatus. A heater for heating and volatilising the aerosol generating material may be provided as a “permanent” part of the apparatus.

An aerosol generating device can receive an article comprising aerosol generating material for heating, also referred to as a “smoking article”. An “article”, “aerosol generating article” or “smoking article” in this context is a component that includes or contains in use the aerosol generating material, which is heated to volatilise the aerosol generating material, and optionally other components in use. A user may insert the article into the aerosol generating device before it is heated to produce an aerosol, which the user subsequently inhales. The article may be, for example, of a predetermined or specific size that is configured to be placed within a heating chamber of the device which is sized to receive the article.

The aerosol generating device according to an embodiment comprises a plurality of heating units, each heating unit being arranged to heat, but not burn, the aerosol generating material in use.

A heating unit typically refers to a component which is arranged to receive electrical energy from an electrical energy source, and to supply thermal energy to an aerosol generating material. A heating unit comprises a heating element. A heating element is typically a material which is arranged to supply heat to an aerosol generating material in use. The heating unit comprising the heating element may comprise any other component required, such as a component for transducing the electrical energy received by the heating unit. In other examples, the heating element itself may be configured to transduce electrical energy to thermal energy.

The heating unit may comprise a coil. In some examples, the coil is configured to, in use, cause heating of at least one electrically-conductive heating element, so that heat energy is conductible from the at least one electrically-conductive heating element to aerosol generating material to thereby cause heating of the aerosol generating material.

In some examples, the coil is configured to generate, in use, a varying magnetic field for penetrating at least one heating element, to thereby cause induction heating and/or magnetic hysteresis heating of the at least one heating element. In such an arrangement, the or each heating element may be termed a “susceptor”. A coil that is configured to generate, in use, a varying magnetic field for penetrating at least one electrically-conductive heating element, to thereby cause induction heating of the at least one electrically-conductive heating element, may be termed an “induction coil” or “inductor coil”.

The device may include the heating element(s), for example electrically-conductive heating element(s), and the heating element(s) may be suitably located or locatable relative to the coil to enable such heating of the heating element(s). The heating element(s) may be in a fixed position relative to the coil. Alternatively, the at least one heating element, for example at least one electrically-conductive heating element, may be included in an article for insertion into a heating zone of the device, wherein the article also comprises the aerosol generating material and is removable from the heating zone after use. Alternatively, both the device and such an article may comprise at least one respective heating element, for example at least one electrically-conductive heating element, and the coil may be to cause heating of the heating element(s) of each of the device and the article when the article is in the heating zone.

In some examples, the coil is helical. In some examples, the coil encircles at least a part of a heating zone of the device that is configured to receive aerosol generating material. In some examples, the coil is a helical coil that encircles at least a part of the heating zone.

In some examples, the device comprises an electrically-conductive heating element that at least partially surrounds the heating zone, and the coil is a helical coil that encircles at least a part of the electrically-conductive heating element. In some examples, the electrically-conductive heating element is tubular. In some examples, the coil is an inductor coil.

In some examples, the heating unit is an induction heating unit. Surprisingly, it has been found by the inventors that induction heating units in an aerosol generating device reach a maximum operating temperature much more rapidly than corresponding resistive heating elements. In an embodiment, the device is configured such that the first (induction) heating unit reaches its maximum operating temperature at a rate of at least 100° C. per second. In a particular embodiment, the device is configured such that the first (induction) heating unit reaches the maximum operating temperature at a rate of at least 150° C. per second.

Induction heating systems may be of interest because the varying magnetic field magnitude can be easily controlled by controlling power supplied to the heating unit. Moreover, as induction heating does not require a physical connection to be provided between the source of the varying magnetic field and the heat source, design freedom and control over the heating profile may be greater, and cost may be lower.

In other examples, the first and/or second heating unit may comprise a resistive heating unit. A resistive heating unit may consist of a resistive heating element. That is, it may be unnecessary for a resistive heating unit to include a separate component for transducing the electrical energy received by the heating unit, because a resistive heating element itself transduces electrical energy to thermal energy.

Using electrical resistance heating systems may be of interest because the rate of heat generation is easier to control, and lower levels of heat are easier to generate, compared with using combustion for heat generation. The use of electrical heating systems therefore allows greater control over the generation of an aerosol from a tobacco composition.

Reference is made to the temperature of heating elements throughout the present specification. The temperature of a heating element may also be conveniently referred to as the temperature of the heating unit which comprises the heating element. This does not necessarily mean that the entire heating unit is at the given temperature. For example, where reference is made to the temperature of an induction heating unit, it does not necessarily mean that the both the inductive element and the susceptor have such a temperature. Rather, in this example, the temperature of the induction heating unit corresponds to the temperature of the heating element composed in the induction heating unit. For the avoidance of doubt, the temperature of a heating element and the temperature of a heating unit can be used interchangeably.

As used herein, “temperature profile” refers to the variation of temperature of a material over time. For example, the varying temperature of a heating element or heating unit measured at the heating element or heating unit for the duration of a smoking session may be referred to as the temperature profile of that heating element or heating unit. The heating elements or heating units provide heat to the aerosol generating material during use, to generate an aerosol. The temperature profile of the heating element or heating unit therefore induces the temperature profile of aerosol generating material disposed near the heating element or heating unit.

As used herein, “puff” refers to a single inhalation by the user of the aerosol generated by the aerosol generating device.

In use, the device may heat an aerosol generating material to provide an inhalable aerosol. The device may be referred to as “ready for use” when at least a portion of the aerosol generating material has reached a lowest operating temperature and a user can take a puff which contains a satisfactory amount of aerosol. In some embodiments the device may be ready for use within approximately 20 seconds of supplying power to the first heating unit, or 15 seconds, or 10 seconds. The device may be ready for use within approximately 20 seconds of activation of the device, or 15 seconds, or 10 seconds. The device may begin supplying power to a heating unit such as the first heating unit when the device is activated, or it may begin supplying power to the heating unit after the device is activated. The device may be configured such that power starts being supplied to the first heating unit some time after activation of the device, such as at least 1 second, 2 seconds or 3 seconds after activation of the device. The device may be configured such that power is not supplied to the first heating unit, or any heating unit present in the heating assembly until at least 2.5 seconds after activation of the device. This may prolong battery life by avoiding unintentional activation of the heating unit(s).

The aerosol generating device may be ready for use more quickly than corresponding aerosol generating devices known in the art, providing an improved user experience. Generally, the point at which the device is ready for use will be some time after the first heating unit has reached its maximum operating temperature, as it will take some amount of time to transfer sufficient thermal energy from the heating unit to the aerosol generating material in order to generate the aerosol. The device may be ready for use within 20 seconds of the first heating unit reaching its maximum operating temperature, or 15 seconds, or 10 seconds.

Further, surprisingly it has been found that characteristics of the aerosol generated from the aerosol generating material may depend on the rate at which the aerosol generating material is heated. For example, the aerosol generated from an aerosol generating material which is subject to heating from a heating unit which is configured to change temperature quickly may provide an improved user experience. In one embodiment wherein the aerosol generating material comprises menthol, it has been found that rapidly increasing the temperature of the heating unit may increase the rate at which menthol is delivered to a user in the aerosol, and thereby reduce the amount of menthol component that is wasted (i.e. does not form part of the aerosol inhaled by a user) from static heating.

In some embodiments, the user's sensorial experience arising from the aerosol generated by the present device is like that of smoking a combustible cigarette, such as a factory-made cigarette.

The device may indicate that it is ready for use via an indicator. In an embodiment, the device may be configured such that the indicator indicates that the device is ready for use within approximately 20 seconds of power being supplied to the first heating unit, or 15 seconds, or 10 seconds. In a particular embodiment, the device is configured such that the indicator indicates that the device is ready for use within approximately 20 seconds of activation of the device, or 15 seconds, or 10 seconds. In another embodiment, the device is configured such that the indicator indicates that the device is ready for use within approximately 20 seconds of the first heating unit reaching its maximum operating temperature, or 15 seconds, or 10 seconds.

“Session of use” as used herein refers to a single period of use of the aerosol generating device by a user. The session of use begins at the point at which power is first supplied to at least one heating unit present in the heating assembly. The device will be ready for use after a period of time has elapsed from the start of the session of use.

The session of use ends at the point at which no power is supplied to any of the heating units in the aerosol generating device. The end of the session of use may coincide with the point at which the aerosol generating article is depleted (the point at which the total particulate matter yield (mg) in each puff would be deemed unacceptably low by a user). The session may comprise a plurality of puffs. The session may have a duration less than 7 minutes, or 6 minutes, or 5 minutes, or 4 minutes and 30 seconds, or 4 minutes, or 3 minutes and 30 seconds. In some embodiments, the session of use may have a duration of from 2 to 5 minutes, or from 3 to 4.5 minutes, or 3.5 to 4.5 minutes, or suitably 4 minutes. A session may be initiated by the user actuating a button or switch on the device, causing at least one heating unit to begin rising in temperature when activated or some time after activation.

“Operating temperature” as used herein in relation to a heating element or heating unit refers to any heating element temperature at which the element can heat an aerosol generating material to produce sufficient aerosol for a satisfactory puff without burning the aerosol generating material. The maximum operating temperature of a heating element is the highest temperature reached by the element during a smoking session. The lowest operating temperature of the heating element refers to the lowest heating element temperature at which sufficient aerosol can be generated from the aerosol generating material by the heating element for a satisfactory puff. Where there is a plurality of heating elements or heating units present in the aerosol generating device, each heating element or heating unit has an associated maximum operating temperature. The maximum operating temperature of each heating element or heating unit may be the same, or it may differ for each heating element or heating unit.

In the aerosol generating device according to an embodiment each heating element or heating unit may be arranged to heat, but not burn, aerosol generating material. Although the temperature profile of each heating element or heating unit may induce the temperature profile of each associated portion of aerosol generating material, the temperature profiles of the heating element or heating unit and the associated portion of aerosol generating material may not exactly correspond. For example: there may be “bleed” in the form of conduction, convection and/or radiation of heat energy from one portion of the aerosol generating material to another; there may be variations in conduction, convection and/or radiation of heat energy from the heating elements or heating units to the aerosol generating material; there may be a lag between the change in the temperature profile of the heating element or heating unit and the change in the temperature profile of the aerosol generating material, depending on the heat capacity of the aerosol generating material.

The device may comprise a controller for controlling each heating unit present in the device. The controller may comprise a PCB. The controller may be configured to control the power supplied to each heating unit, and controls the “programmed heating profile” of each heating unit present in the device. For example, the controller may be programmed to control the current supplied to a plurality of inductors to control the resulting temperature profiles of the corresponding induction heating elements or induction heating units. As between the temperature profile of heating elements/units and aerosol generating material described above, the programmed heating profile of a heating element or heating unit may not exactly correspond to the observed temperature profile of a heating element or heating unit, for the same reasons given above.

The term “operating temperature” can also be used in relation to the aerosol generating material. In this case, the term refers to any temperature of the aerosol generating material itself at which sufficient aerosol is generated from the aerosol generating material for a satisfactory puff. The maximum operating temperature of the aerosol generating material is the highest temperature reached by any part of the aerosol generating material during a smoking session. In some embodiments, the maximum operating temperature of the aerosol generating material is greater than 200° C., 210° C., 220° C., 230° C., 240° C., 250° C., 260° C., or 270° C. In some embodiments, the maximum operating temperature of the aerosol generating material is less than 300° C., 290° C., 280° C., 270° C., 260° C., 250° C. The lowest operating temperature is the lowest temperature of aerosol generating material at which sufficient aerosol is generated from the material to product sufficient aerosol for a satisfactory “puff”. In some embodiments, the lowest operating temperature of the aerosol generating material is greater than 90° C., 100° C., 110° C., 120° C., 130° C., 140° C. or 150° C. In some embodiments, the lowest operating temperature of the aerosol generating material is less than 150° C., 140° C., 130° C., or 120° C.

An object of various embodiments is to reduce the amount of time it takes for an aerosol generating device to be ready for use, and more generally improve the inhalation experience for a user. Surprisingly, it has been found that reducing the time taken for a heating element or heating unit to reach an operating temperature may at least partially alleviate “hot puff”, a phenomenon which occurs when the generated aerosol contains a high water content. Accordingly, the aerosol generating device according to various embodiments may provide an inhalable aerosol to a consumer which has better organoleptic properties than an aerosol provided by a conventional aerosol generating device which does not include a heating unit which reaches a maximum operating temperature as rapidly.

In some embodiments, the device is configured such that at least one heating element in the device reaches its maximum operating temperature within 20 seconds, and the first temperature at which the at least one heating unit is held for at least 1 second, 2 seconds, 3 seconds, 4 seconds, 5 seconds, 10 seconds, or 20 seconds is the maximum operating temperature. That is, in these embodiments, the heating unit is not held at a temperature which is not the maximum operating temperature before reaching the maximum operating temperature.

In some embodiments, the at least one heating unit reaches its maximum operating temperature within the given period from ambient temperature.

The device may be configured to operate as described herein. The device may at least partially be configured to operate in this manner by a controller which may be programmed to operate the device in one or more different modes. Accordingly, references herein to the configuration of the device or components thereof may refer to the controller being programmed to operate the device as disclosed herein, amongst other features (such as spatial arrangement of the heating units).

Aerosol generating articles for aerosol generating devices (such as tobacco heating products) usually contain more water and/or aerosol generating agent than combustible smoking articles to facilitate formation of an aerosol in use. This higher water and/or aerosol generating agent content can increase the risk of condensate collecting within the aerosol generating device during use, particularly in locations away from the heating unit(s). This problem may be greater in devices with enclosed heating chambers, and particularly those with external heaters, than those provided with internal heaters (such as “blade” heaters). Without wishing to be bound by theory, it is believed that since a greater proportion/surface area of the aerosol generating material is heated by external-heating heating assemblies, more aerosol is released than a device which heats the aerosol generating material internally, leading to more condensation of the aerosol within the device. The inventors have found that programmed heating profiles of the present disclosure may be employed in a device configured to externally heat aerosol generating material to provide a desirable amount of aerosol to the user whilst keeping the amount of aerosol which condenses inside the device low. For example, the maximum operating temperature of a heating unit may affect the amount of condensate formed. It may be that lower maximum operating temperatures provide less undesirable condensate. The difference between maximum operating temperatures of heating units in a heating assembly may also affect the amount of condensate formed. Further, the point in a session of use at which each heating unit reaches its maximum operating temperature may affect the amount of condensate formed.

In some embodiments, the device is operable in at least a first (e.g. base) mode and a second (e.g. boost) mode.

The heating assembly may be operable in a maximum of two modes, or may be operable in more than two modes, such as three modes, four modes, or five modes.

Each mode may be associated with a predetermined heating profile for each heating unit in the heating assembly, such as a programmed heating profile. One or more of the programmed heating profiles may be programmed by a user. Additionally, or alternatively, one or more of the programmed heating profiles may be programmed by the manufacturer. In these examples, the one or more programmed heating profiles may be fixed such that an end user cannot alter the one or more programmed heating profiles.

The modes of operation may be selectable by a user. For example, the user may select a desired mode of operation by interacting with a user interface. Power may begin to be supplied to the first heating unit at substantially the same time as the desired mode of operation is selected.

Each mode may be associated with a temperature profile which differs from the temperature profiles of the other modes. Further, one or more modes may be associated with a different point at which the device is ready for use. For example, the heating assembly may configured such that, in the first mode, the device is ready for use a first period of time after the start of a session of use, and in the second mode, the device is ready for use a second period of time after the start of the session. The first period of time may be different from the second period of time. The second period of time associated with the second mode may be shorter than the first period of time associated with the second mode.

In some examples, the heating assembly is configured such that the device is ready for use within 30, 25 seconds, 20 seconds or 15 seconds of supplying power to the first heating unit when operated in the first mode. The heating assembly may also be configured such that the device is ready for use in a shorter period of time when operating in the second mode—within 25 seconds, 20 seconds, 15 seconds, or 10 seconds of supplying power to the first heating unit when operating in the second mode. The heating assembly may be configured such that the device is ready for use within 20 seconds of supplying power to the first heating unit when operated in the first mode, and within 10 seconds of supplying power to the second heating unit when operated in the second mode. The second mode of this embodiment may also be associated with the first and/or second heating unit having a higher maximum operating temperature in use.

In a particular embodiment, the device is configured such that the indicator indicates that the device is ready for use within 20 seconds of selection of the first (e.g. base) mode, and within 10 seconds of selection of the second (e.g. boost) mode.

Providing an aerosol generating device such as a tobacco heating product with a heating assembly that is operable in a plurality of modes (e.g. base mode and boost mode) gives more choice to the consumer, particularly where each mode is associated with a different maximum heater temperature. Moreover, such a device is capable of providing different aerosols having differing characteristics, because volatile components in the aerosol generating material will be volatilised at different rates and concentrations at different heater temperatures. This allows a user to select a particular mode based on a desired characteristic of the inhalable aerosol, such as degree of tobacco flavour, nicotine concentration, and aerosol temperature. For example, modes in which the device is ready for use more quickly (e.g. a second or “boost” mode) may provide a quicker first puff, or a greater nicotine content per puff, or a more concentrated flavour per puff. Conversely, modes in which the device is ready for use at a later point in the session (e.g. a first or base mode) of use may provide a longer overall session of use, lower nicotine content per puff, and more sustained delivery of flavour.

In embodiments wherein the device is ready for use more quickly in a second (e.g. boost) mode, and/or the first and/or second heating unit has a higher maximum operating temperature in the second mode, the second mode may be referred to as a “boost” mode. For the first time, aspects provide an aerosol generating device which is operable in a first “normal” mode, and a second “boost” mode. The “boost” mode may provide a quicker first puff, or a greater nicotine content per puff, or a more concentrated flavour per puff.

The device may comprise a maximum of two heating units. In other examples, the device may comprise more than two independently controllable heating units, such as three, four or five independently controllable heating units.

The device may be configured such that each heating unit present in the device reaches a first-mode maximum operating temperature in the first mode, and a second-mode maximum operating temperature in the second mode. For example, the second heating unit may reach a first-mode maximum operating temperature in the first mode, and a second-mode maximum operating temperature in the second mode. The maximum operating temperature of each heating unit in each mode may be the same, or may be different. For example, the maximum operating temperature of the second heating unit in each mode may or may not be the same as the maximum operating temperature of the first heating unit in each mode.

As discussed hereinabove, in some embodiments, at least one of the heating units provided in the heating assembly may comprise an induction heating unit. In these embodiments, the heating unit comprises an inductor (for example, one or more inductor coils), and the device may be arranged to pass a varying electrical current, such as an alternating current, through the inductor. The varying electric current in the inductor produces a varying magnetic field. When the inductor and the heating element are suitably relatively positioned so that the varying magnetic field produced by the inductor penetrates the heating element, one or more eddy currents are generated inside the heating element. The heating element has a resistance to the flow of electrical currents, so when such eddy currents are generated in the object, their flow against the electrical resistance of the object causes the object to be heated by Joule heating. Supplying a varying magnetic field to a susceptor may conveniently be referred to as supplying energy to a susceptor.

The first and second heating units (which may comprise induction or resistive heating units) may be controllable independent from each other. Heating the aerosol generating material with independent heating units may provide more accurate control of heating of the aerosol generating material. Independently controllable heating units may also provide thermal energy differently to each portion of the aerosol generating material, resulting in differing temperature profiles across portions of the aerosol generating material. In particular embodiments, the first and second heating units are configured to have temperature profiles which differ from each other in use. This may provide asymmetrical heating of the aerosol generating material along a longitudinal plane between the mouth end and the distal end of the device when the device is in use.

An object that is capable of being inductively heated is known as a susceptor. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive heater and the susceptor, allowing for enhanced freedom in construction and application.

The heating element may comprise a susceptor. In embodiments, the susceptor comprises a plurality of heating elements—at least a first induction heating element and a second induction heating element.

In other embodiments, the heating units are not limited to induction heating units. For example, the first heating unit may comprise an electrical resistance heating unit which may consist of a resistive heating element. The second heating unit may additionally or alternatively be an electrical resistance heating unit which may consist of a resistive heating element. By “resistive heating element”, it is meant that on application of a current to the element, resistance in the element transduces electrical energy into thermal energy which heats the aerosol generating substrate. The heating element may be in the form of a resistive wire, mesh, coil and/or a plurality of wires. The heat source may comprise a thin-film heater.

The heating element may comprise a metal or metal alloy. Metals are excellent conductors of electricity and thermal energy. Suitable metals include but are not limited to: copper, aluminium, platinum, tungsten, gold, silver, and titanium. Suitable metal alloys include but are not limited to: nichrome and stainless steel.

Another aspect is an aerosol generating system comprising an aerosol generating device as described herein in combination with an aerosol generating article. In an embodiment, the aerosol generating system comprises a tobacco heating product in combination with an aerosol generating article comprising tobacco. In suitable embodiments the tobacco heating product may comprise the heating arrangement and aerosol generating article described in relation to the figures hereinbelow.

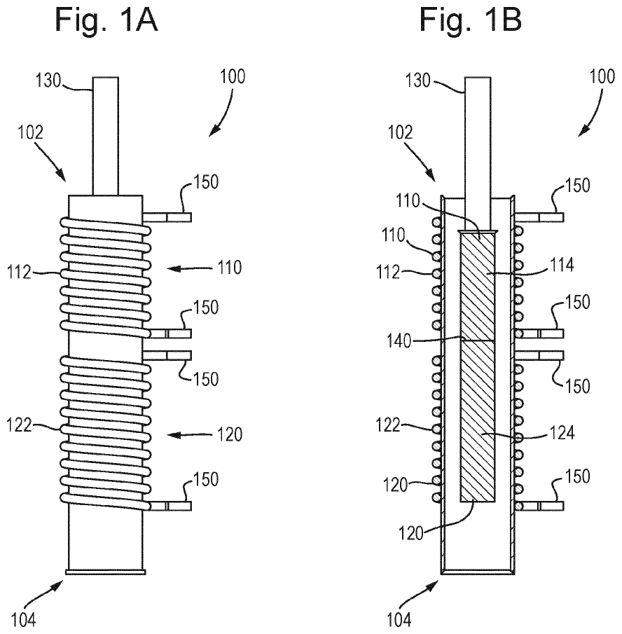

FIG. 1A shows an induction heating assembly 100 of an aerosol generating device according to an embodiment. FIG. 1B shows a cross section of the induction heating assembly 100 of the device.

The heating assembly 100 has a first or proximal or mouth end 102, and a second or distal end 104. In use, the user will inhale the formed aerosol from the mouth end of the aerosol generating device. The mouth end may be an open end.

The heating assembly 100 comprises a first induction heating unit 110 and a second induction heating unit 120. The first induction heating unit 110 comprises a first inductor coil 112 and a first heating element 114. The second induction heating unit 120 comprises a second inductor coil 122 and a second heating element 124.

FIGS. 1A and 1B show an aerosol generating article 130 received within a susceptor 140 (see FIG. 1B). The susceptor 140 forms the first induction heating element 114 and the second induction heating element 124. The susceptor 140 may be formed from any material suitable for heating by induction. For example, the susceptor 140 may comprise metal. In some embodiments, the susceptor 140 may comprise non-ferrous metal such as copper, nickel, titanium, aluminium, tin, or zinc, and/or ferrous material such as iron, nickel or cobalt. Additionally or alternatively the susceptor 140 may comprise a semiconductor such as silicon carbide, carbon or graphite.

Each induction heating element present in the aerosol generating device may have any suitable shape. In the embodiment shown in FIG. 1B, the induction heating elements 114,124 define a receptacle to surround an aerosol generating article and heat the aerosol generating article externally. In other embodiments (not shown), one or more induction heating elements may be substantially elongate, arranged to penetrate an aerosol generating article and heat the aerosol generating article internally.

As shown in FIG. 1B, the first induction heating element 114 and second induction heating element 124 may be provided together as a monolithic element 140. That is, in some embodiments, there is no physical distinction between the first 114 and second 124 heating elements. Rather, the differing characteristics between the first and second heating units 110, 120 are defined by separate inductor coils 112,122 surrounding each induction heating element 114,124, so that they may be controlled independently from each other. In other embodiments (not depicted), physically distinct inductive heating elements may be employed.

The first and second inductor coils 112,122 may be made from an electrically conducting material. In this example, the first and second inductor coils 112,122 are made from Litz wire/cable which is wound in a helical fashion to provide helical inductor coils 112,122. Litz wire comprises a plurality of individual wires which are individually insulated and are twisted together to form a single wire. Litz wires are designed to reduce the skin effect losses in a conductor. In the example induction heating assembly 100, the first and second inductor coils 124,126 are made from copper Litz wire which has a circular cross section. In other examples the Litz wire can have other shape cross sections, such as rectangular.

The first inductor coil 112 is configured to generate a first varying magnetic field for heating the first induction heating element 114, and the second inductor coil 122 is configured to generate a second varying magnetic field for heating a second section of the susceptor 124. The first inductor coil 112 and the first induction heating element 114 taken together form a first induction heating unit 110. Similarly, the second inductor coil 122 and the second induction heating element 124 taken together form a second induction heating unit 120.

In this example, the first inductor coil 112 is adjacent to the second inductor coil 122 in a direction along the longitudinal axis of the device heating assembly 100 (that is, the first and second inductor coils 112,122 do not overlap). The susceptor arrangement 140 may comprise a single susceptor. Ends 150 of the first and second inductor coils 112,122 can be connected to a controller such as a PCB (not shown). In embodiments, the controller comprises a PID controller (proportional integral derivative controller).

The varying magnetic field generates eddy currents within the first inductive heating element 114, thereby rapidly heating the first induction heating element 114 to a maximum operating temperature within a short period of time from supplying the alternative current to the coil 112, for example within 20, 15, 12, 10, 5, or 2 seconds. Arranging the first induction heating unit 110 which is configured to rapidly reach a maximum operating temperature closer to the mouth end 102 of the heating assembly 100 than the second induction heating unit 120 may mean that an acceptable aerosol is provided to a user as soon as possible after initiation of a session of use.

It will be appreciated that the first and second inductor coils 112,122, in some examples, may have at least one characteristic different from each other. For example, the first inductor coil 112 may have at least one characteristic different from the second inductor coil 122. More specifically, in one example, the first inductor coil 112 may have a different value of inductance than the second inductor coil 122. In FIGS. 1A and 1B, the first and second inductor coils 112,122 are of different lengths such that the first inductor coil 112 is wound over a smaller section of the susceptor 140 than the second inductor coil 122. Thus, the first inductor coil 112 may comprise a different number of turns than the second inductor coil 122 (assuming that the spacing between individual turns is substantially the same). In yet another example, the first inductor coil 112 may be made from a different material to the second inductor coil 122. In some examples, the first and second inductor coils 112,122 may be substantially identical.

In this example, the first inductor coil 112 and the second inductor coil 122 are wound in the same direction. However, in another embodiment, the inductor coils 112,122 may be wound in opposite directions. This can be useful when the inductor coils are active at different times. For example, initially, the first inductor coil 112 may be operating to heat the first induction heating element 114, and at a later time, the second inductor coil 122 may be operating to heat the second induction heating element 124. Winding the coils in opposite directions helps reduce the current induced in the inactive coil when used in conjunction with a particular type of control circuit. In one example, the first inductor coil 112 may be a right-hand helix and the second inductor coil 122 a left-hand helix. In another example, the first inductor coil 112 may be a left-hand helix and the second inductor coil 122 may be a right-hand helix.

The coils 112,122 may have any suitable geometry. Without wishing to be bound by theory, configuring an induction heating element to be smaller (e.g. smaller pitch helix; fewer revolutions in the helix; shorter overall length of the helix), may increase the rate at which the induction heating element can reach a maximum operating temperature. In some embodiments, the first coil 112 may have a length of less than approximately 20 mm, less than 18 mm, less than 16 mm, or a length of approximately 14 mm, in the longitudinal direction of the heating assembly 100. The first coil 112 may have a length shorter than the second coil 124 in the longitudinal direction of the heating assembly 100. Such an arrangement may provide asymmetrical heating of the aerosol generating article along the length of the aerosol generating article.

The susceptor 140 of this example is hollow and therefore defines a receptacle within which aerosol generating material is received. For example, the article 130 can be inserted into the susceptor 140. In this example the susceptor 140 is tubular, with a circular cross section.

The induction heating elements 114 and 124 are arranged to surround the aerosol generating article 130 and heat the aerosol generating article 130 externally. The aerosol generating device is configured such that, when the aerosol generating article 130 is received within the susceptor 140, the outer surface of the article 130 abuts the inner surface of the susceptor 140. This ensures that the heating is most efficient. The article 130 of this example comprises aerosol generating material. The aerosol generating material is positioned within the susceptor 140. The article 130 may also comprise other components such as a filter, wrapping materials and/or a cooling structure.

The heating assembly 100 is not limited to two heating units. In some examples, the heating assembly 100 may comprise three, four, five, six, or more than six heating units. These heating units may each be controllable independent from the other heating units present in the heating assembly 100.

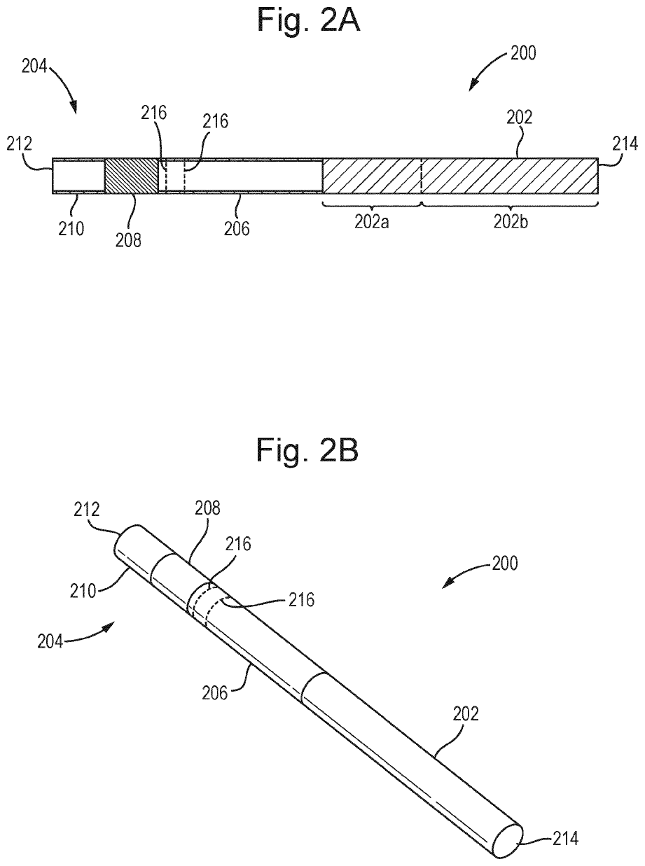

Referring to FIGS. 2A and 2B, there is shown a partially cut-away section view and a perspective view of an example of an aerosol generating article 200. The aerosol generating article 200 shown in FIGS. 2A and 2B corresponds to the aerosol generating article 130 shown in FIG. 1.

The aerosol generating article 200 may be any shape suitable for use with an aerosol generating device. The aerosol generating article 130 may be in the form of or provided as part of a cartridge or cassette or rod which can be inserted into the apparatus. In the embodiment shown in FIGS. 1A and 1B and 2, the aerosol generating article 130 is in the form of a substantially cylindrical rod that includes a body of smokable material 202 and a filter assembly 204 in the form of a rod. The filter assembly 204 includes three segments, a cooling segment 206, a filter segment 208 and a mouth end segment 210. The article 200 has a first end 212, also known as a mouth end or a proximal end and a second end 214, also known as a distal end. The body of aerosol generating material 202 is located towards the distal end 214 of the article 200. In one example, the cooling segment 206 is located adjacent the body of aerosol generating material 202 between the body of aerosol generating material 202 and the filter segment 208, such that the cooling segment 206 is in an abutting relationship with the aerosol generating material 202 and the filter segment 208. In other examples, there may be a separation between the body of aerosol generating material 202 and the cooling segment 206 and between the body of aerosol generating material 202 and the filter segment 208. The filter segment 208 is located in between the cooling segment 206 and the mouth end segment 210. The mouth end segment 210 is located towards the proximal end 212 of the article 200, adjacent the filter segment 208. In one example, the filter segment 208 is in an abutting relationship with the mouth end segment 210. In one embodiment, the total length of the filter assembly 204 is between 37 mm and 45 mm, and optionally the total length of the filter assembly 204 is 41 mm.

In use, portions 202a and 202b of the body of aerosol generating material 202 may correspond to the first induction heating element 114 and second induction heating element 124 of the portion 100 shown in FIG. 1B respectively.

The body of smokable material may have a plurality of portions 202a,202b which correspond to the plurality of induction heating elements present in the aerosol generating device. For example, the aerosol generating article 200 may have a first portion 202a which corresponds to the first induction heating element 114 and a second portion 202b which corresponds to the second induction heating element 124. These portions 202a,202b may exhibit temperature profiles which are different from each other during a session of use; the temperature profiles of the portions 202a,202b may derive from the temperature profiles of the first induction heating element 114 and second induction heating element 124 respectively.

Where there is a plurality of portions 202a,202b of a body of aerosol generating material 202, any number of the substrate portions 202a,202b may have substantially the same composition. In a particular example, all of the portions 202a,202b of the substrate have substantially the same composition. In one embodiment, body of aerosol generating material 202 is a unitary, continuous body and there is no physical separation between the first and second portions 202a,202b, and the first and second portions have substantially the same composition.

In one embodiment, the body of aerosol generating material 202 comprises tobacco. However, in other respective embodiments, the body of smokable material 202 may consist of tobacco, may consist substantially entirely of tobacco, may comprise tobacco and aerosol generating material other than tobacco, may comprise aerosol generating material other than tobacco, or may be free of tobacco. The aerosol generating material may include an aerosol generating agent, such as glycerol.

In a particular embodiment, the aerosol generating material may comprise one or more tobacco components, filler components, binders and aerosol generating agents.

The filler component may be any suitable inorganic filler material. Suitable inorganic filler materials include, but are not limited to: calcium carbonate (i.e. chalk), perlite, vermiculite, diatomaceous earth, colloidal silica, magnesium oxide, magnesium sulphate, magnesium carbonate, and suitable inorganic sorbents, such as molecular sieves. Calcium carbonate is particularly suitable. In some cases, the filler comprises an organic material such as wood pulp, cellulose and cellulose derivatives.

The binder may be any suitable binder. In some embodiments, the binder comprises one or more of an alginate, celluloses or modified celluloses, polysaccharides, starches or modified starches, and natural gums.

Suitable binders include, but are not limited to: alginate salts comprising any suitable cation, such as sodium alginate, calcium alginate, and potassium alginate; celluloses or modified celluloses, such as hydroxypropyl cellulose and carboxymethylcellulose; starches or modified starches; polysaccharides such as pectin salts comprising any suitable cation, such as sodium, potassium, calcium or magnesium pectate; xanthan gum, guar gum, and any other suitable natural gums.

A binder may be included in the aerosol generating material in any suitable quantity and concentration.

The “aerosol generating agent” is an agent that promotes the generation of an aerosol. An aerosol generating agent may promote the generation of an aerosol by promoting an initial vaporisation and/or the condensation of a gas to an inhalable solid and/or liquid aerosol. In some embodiments, an aerosol generating agent may improve the delivery of flavour from the aerosol generating article.

In general, any suitable aerosol generating agent or agents may be included in the aerosol generating material. Suitable aerosol generating agent include, but are not limited to: a polyol such as sorbitol, glycerol, and glycols like propylene glycol or triethylene glycol; a non-polyol such as monohydric alcohols, high boiling point hydrocarbons, acids such as lactic acid, glycerol derivatives, esters such as diacetin, triacetin, triethylene glycol diacetate, triethyl citrate or myristates including ethyl myristate and isopropyl myristate and aliphatic carboxylic acid esters such as methyl stearate, dimethyl dodecanedioate and dimethyl tetradecanedioate.

In a particular embodiment, the aerosol generating material comprises a tobacco component in an amount of from 60 to 90% by weight of the tobacco composition, a filler component in an amount of 0 to 20% by weight of the tobacco composition, and an aerosol generating agent in an amount of from 10 to 20% by weight of the tobacco composition. The tobacco component may comprise paper reconstituted tobacco in an amount of from 70 to 100% by weight of the tobacco component.

In one example, the body of aerosol generating material 202 is between 34 mm and 50 mm in length, optionally, the body of aerosol generating material 202 is between 38 mm and 46 mm in length, optionally still, the body of aerosol generating material 202 is 42 mm in length.

In one example, the total length of the article 200 is between 71 mm and 95 mm, optionally, total length of the article 200 is between 79 mm and 87 mm, optionally still, total length of the article 200 is 83 mm.

An axial end of the body of aerosol generating material 202 is visible at the distal end 214 of the article 200. However, in other embodiments, the distal end 214 of the article 200 may comprise an end member (not shown) covering the axial end of the body of aerosol generating material 202.

The body of aerosol generating material 202 is joined to the filter assembly 204 by annular tipping paper (not shown), which is located substantially around the circumference of the filter assembly 204 to surround the filter assembly 204 and extends partially along the length of the body of aerosol generating material 202. In one example, the tipping paper is made of 58GSM standard tipping base paper. In one example has a length of between 42 mm and 50 mm, and optionally, the tipping paper has a length of 46 mm.

In one example, the cooling segment 206 is an annular tube and is located around and defines an air gap within the cooling segment. The air gap provides a chamber for heated volatilised components generated from the body of aerosol generating material 202 to flow. The cooling segment 206 is hollow to provide a chamber for aerosol accumulation yet rigid enough to withstand axial compressive forces and bending moments that might arise during manufacture and whilst the article 200 is in use during insertion into the device 100. In one example, the thickness of the wall of the cooling segment 206 is approximately 0.29 mm.

The cooling segment 206 provides a physical displacement between the aerosol generating material 202 and the filter segment 208. The physical displacement provided by the cooling segment 206 will provide a thermal gradient across the length of the cooling segment 206. In one example the cooling segment 206 is configured to provide a temperature differential of at least 40° C. between a heated volatilised component entering a first end of the cooling segment 206 and a heated volatilised component exiting a second end of the cooling segment 206. In one example the cooling segment 206 is configured to provide a temperature differential of at least 60° C. between a heated volatilised component entering a first end of the cooling segment 206 and a heated volatilised component exiting a second end of the cooling segment 206. This temperature differential across the length of the cooling element 206 protects the temperature sensitive filter segment 208 from the high temperatures of the aerosol generating material 202 when it is heated by the heating assembly 100 of the device aerosol generating device. If the physical displacement was not provided between the filter segment 208 and the body of aerosol generating material 202 and the heating elements 114,124 of the heating assembly 100, then the temperature sensitive filter segment may 208 become damaged in use, so it would not perform its required functions as effectively.

In one example the length of the cooling segment 206 is at least 15 mm. In one example, the length of the cooling segment 206 is between 20 mm and 30 mm, more particularly 23 mm to 27 mm, more particularly 25 mm to 27 mm and more particularly 25 mm.

The cooling segment 206 is made of paper, which means that it is comprised of a material that does not generate compounds of concern, for example, toxic compounds when in use adjacent to the heater assembly 100 of the aerosol generating device. In one example, the cooling segment 206 is manufactured from a spirally wound paper tube which provides a hollow internal chamber yet maintains mechanical rigidity. Spirally wound paper tubes are able to meet the tight dimensional accuracy requirements of high-speed manufacturing processes with respect to tube length, outer diameter, roundness and straightness.

In another example, the cooling segment 206 is a recess created from stiff plug wrap or tipping paper. The stiff plug wrap or tipping paper is manufactured to have a rigidity that is sufficient to withstand the axial compressive forces and bending moments that might arise during manufacture and whilst the article 200 is in use during insertion into the device 100.

For each of the examples of the cooling segment 206, the dimensional accuracy of the cooling segment is sufficient to meet the dimensional accuracy requirements of high-speed manufacturing process.

The filter segment 208 may be formed of any filter material sufficient to remove one or more volatilised compounds from heated volatilised components from the smokable material. In one example the filter segment 208 is made of a mono-acetate material, such as cellulose acetate. The filter segment 208 provides cooling and irritation-reduction from the heated volatilised components without depleting the quantity of the heated volatilised components to an unsatisfactory level for a user.

The density of the cellulose acetate tow material of the filter segment 208 controls the pressure drop across the filter segment 208, which in turn controls the draw resistance of the article 200. Therefore, the selection of the material of the filter segment 208 is important in controlling the resistance to draw of the article 200. In addition, the filter segment 208 performs a filtration function in the article 200.

In one example, the filter segment 208 is made of a 8Y15 grade of filter tow material, which provides a filtration effect on the heated volatilised material, whilst also reducing the size of condensed aerosol droplets which result from the heated volatilised material which consequentially reduces the irritation and throat impact of the heated volatilised material to satisfactory levels.

The presence of the filter segment 208 provides an insulating effect by providing further cooling to the heated volatilised components that exit the cooling segment 206. This further cooling effect reduces the contact temperature of the user's lips on the surface of the filter segment 208.

One or more flavours may be added to the filter segment 208 in the form of either direct injection of flavoured liquids into the filter segment 208 or by embedding or arranging one or more flavoured breakable capsules or other flavour carriers within the cellulose acetate tow of the filter segment 208.

In one example, the filter segment 208 is between 6 mm to 10 mm in length, optionally 8 mm.

The mouth end segment 210 is an annular tube and is located around and defines an air gap within the mouth end segment 210. The air gap provides a chamber for heated volatilised components that flow from the filter segment 208. The mouth end segment 210 is hollow to provide a chamber for aerosol accumulation yet rigid enough to withstand axial compressive forces and bending moments that might arise during manufacture and whilst the article is in use during insertion into the device 100. In one example, the thickness of the wall of the mouth end segment 210 is approximately 0.29 mm.

In one example, the length of the mouth end segment 210 is between 6 mm to 10 mm and optionally 8 mm. In one example, the thickness of the mouth end segment is 0.29 mm.

The mouth end segment 210 may be manufactured from a spirally wound paper tube which provides a hollow internal chamber yet maintains critical mechanical rigidity. Spirally wound paper tubes are able to meet the tight dimensional accuracy requirements of high-speed manufacturing processes with respect to tube length, outer diameter, roundness and straightness.

The mouth end segment 210 provides the function of preventing any liquid condensate that accumulates at the exit of the filter segment 208 from coming into direct contact with a user.

It should be appreciated that, in one example, the mouth end segment 210 and the cooling segment 206 may be formed of a single tube and the filter segment 208 is located within that tube separating the mouth end segment 210 and the cooling segment 206.

A ventilation region 216 is provided in the article 200 to enable air to flow into the interior of the article 200 from the exterior of the article 200. In one example the ventilation region 216 takes the form of one or more ventilation holes 216 formed through the outer layer of the article 200. The ventilation holes may be located in the cooling segment 206 to aid with the cooling of the article 200. In one example, the ventilation region 216 comprises one or more rows of holes, and optionally, each row of holes is arranged circumferentially around the article 200 in a cross-section that is substantially perpendicular to a longitudinal axis of the article 200.

In one example, there are between one to four rows of ventilation holes to provide ventilation for the article 200. Each row of ventilation holes may have between 12 to 36 ventilation holes 216. The ventilation holes 216 may, for example, be between 100 to 500 μm in diameter. In one example, an axial separation between rows of ventilation holes 216 is between 0.25 mm and 0.75 mm, optionally, an axial separation between rows of ventilation holes 216 is 0.5 mm.

In one example, the ventilation holes 216 are of uniform size. In another example, the ventilation holes 216 vary in size. The ventilation holes can be made using any suitable technique, for example, one or more of the following techniques: laser technology, mechanical perforation of the cooling segment 206 or pre-perforation of the cooling segment 206 before it is formed into the article 200. The ventilation holes 216 are positioned so as to provide effective cooling to the article 200.

In one example, the rows of ventilation holes 216 are located at least 11 mm from the proximal end 212 of the article, optionally the ventilation holes are located between 17 mm and 20 mm from the proximal end 212 of the article 200. The location of the ventilation holes 216 is positioned such that user does not block the ventilation holes 216 when the article 200 is in use.

Providing the rows of ventilation holes between 17 mm and 20 mm from the proximal end 212 of the article 200 enables the ventilation holes 216 to be located outside of the device 100, when the article 200 is fully inserted in the device 100, as can be seen in FIG. 1. By locating the ventilation holes outside of the apparatus, non-heated air is able to enter the article 200 through the ventilation holes from outside the device 100 to aid with the cooling of the article 200.

The length of the cooling segment 206 is such that the cooling segment 206 will be partially inserted into the device 100, when the article 200 is fully inserted into the device 100. The length of the cooling segment 206 provides a first function of providing a physical gap between the heater arrangement of the device 100 and the heat sensitive filter arrangement 208, and a second function of enabling the ventilation holes 216 to be located in the cooling segment, whilst also being located outside of the device 100, when the article 200 is fully inserted into the device 100. As can be seen from FIG. 1, the majority of the cooling element 206 is located within the device 100. However, there is a portion of the cooling element 206 that extends out of the device 100. It is in this portion of the cooling element 206 that extends out of the device 100 in which the ventilation holes 216 are located.

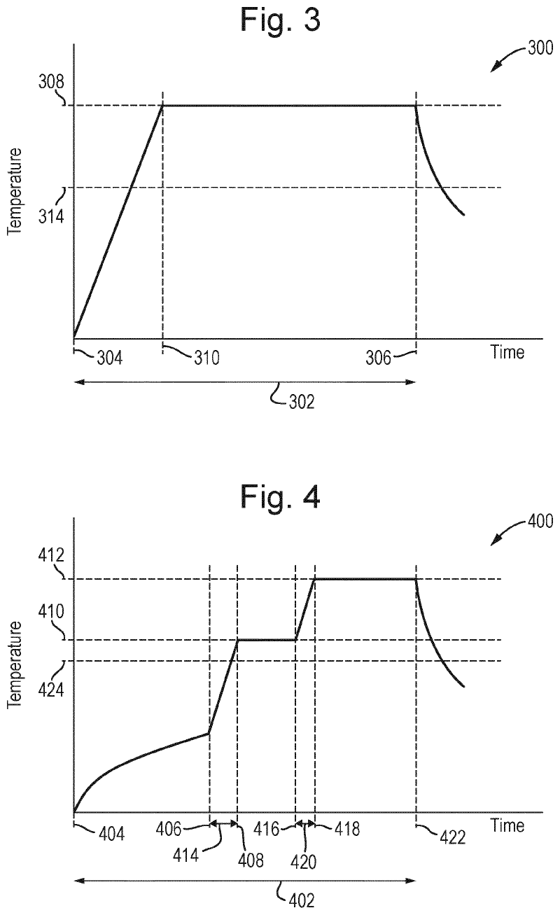

FIG. 3 depicts a temperature profile 300 of a first heating element in an aerosol generating device, such as the first inductive heating element 114 shown in FIG. 1B, during an exemplary session of use 302. The temperature profile 300 suitably refers to the temperature profile of the first inductive heating element 114 in any mode of operation of the heating assembly. The temperature profile 300 of the first heating element 114 is measured by a suitable temperature sensor disposed at the first heating element 114. Suitable temperature sensors include thermocouples, thermopiles or resistance temperature detectors (RTDs, also referred to as resistance thermometers). In a particular embodiment, the device comprises at least one RTD. In an embodiment, the device comprises thermocouples arranged on each heating element 114,124 present in the aerosol generating device. The temperature data measured by the or each temperature sensor may be communicated to a controller. Further, it may communicated to the controller when a heating element 114,124 has reached a prescribed temperature, such that the controller may change the supply of power to elements within the aerosol generating device accordingly. Optionally, the controller comprises a PID (proportional integral derivative) controller, which uses a control loop feedback mechanism to control the temperature of the heating elements based on data supplied from one or more temperature sensors disposed in the device. In an embodiment, the controller comprises a PID controller configured to control the temperature of each heating element based on temperature data supplied from thermocouples disposed at each of the heating elements.

The session of use 302 begins when the device is activated 304 and the controller controls the device to supply energy to at least the first induction heating unit 110. The device may be activated by a user by, for example, actuating a push button, or inhaling from the device. Actuating means for use with an aerosol generating device are known to the person skilled in the art. In the context of a heater assembly comprising induction heating means, the session of use begins when the controller instructs a varying electrical current to be supplied to an inductor (such as first and second coils 112,122) and thus a varying magnetic field to be supplied to the induction heating element, generating a rise in temperature of the induction heating element. As mentioned hereinabove, this may conveniently be referred to as “supplying energy to the induction heating unit”.

The end 306 of the session of use session of use 302 occurs when the controller instructs elements in the device to stop supplying energy to all heating units present in the aerosol generating device. In the context of a heater assembly comprising induction heating units, the session of use ends when varying electrical current ceases to be supplied to any of the induction heating elements provided in the heating assembly, such that any varying magnetic field ceases to be supplied to the induction heating elements.

At the beginning of the smoking session 302 the temperature of the first heating element rapidly increases until it reaches the maximum operating temperature 308. The time taken 310 to reach the maximum operating temperature 308 may be referred to as the “ramp-up” period, and has a duration of less than 20 seconds according to various embodiments.

The temperature of the first heating element may optionally drop from the maximum operating temperature 308 to a lower temperature 314 later in the session of use 312. If the temperature drops from the maximum operating temperature 308 later in the session of use 302, it is preferred that the temperature to which the first heating element drops 314 is an operating temperature. The operating temperature to which the first heating element drops 314 may suitable be referred to as the “second operating temperature” 314. Optionally, the temperature of the first heating element does not drop below the lowest operating temperature of the first heating element until the end 306 of the session of use 302. The first heating element optionally remains at or above the second operating temperature 314 until the end 306 of the session of use 302.

In embodiments wherein the heating assembly is operable in a plurality of modes (e.g. base mode and boost mode), the temperature of the first heating element may drop from the maximum operating temperature 308 to a second operating temperature 314 in at least one of the modes. Optionally, the temperature of the first heating element drops from the maximum operating temperature 308 to a second operating temperature 314 in all of the operable modes. For the avoidance of doubt, the maximum operating temperature 308 and second operating temperature 314 of the first heating element may differ from mode to mode.

In some examples, the second operating temperature 314 is from 180 to 240° C. Where the heating assembly is operable in a plurality of modes, the second operating temperature 314 in at least one mode of operation may be from 180 to 240° C. Optionally, the second operating temperature 314 in all modes of operating may be from 180 to 240° C. Optionally still, the second operating temperature 314 is at least 220° C. In some examples, the first heating element or heating units remains at or above the second operating temperature 314 until the end of the session of use in all modes of operation. Without wishing to be bound by theory, configuring the heating assembly such that the first heating element does not drop below 220° C. until the end of the session of use 220 may at least partially prevent condensation from occurring in the first portion of the aerosol generating article during the session of use, and/or also reduce resistance to draw provided by the first portion of the aerosol generating article.

In these embodiments, the first heating element may remain at or substantially close to the highest operating temperature for up to least 25%, 50%, or 75% of the session. For example, the first heating element may remain at its maximum operating temperature for a first duration of the session of use, then drop to and remain at the second operating temperature for a second duration of the session of use, the first duration being at least 25%, 50%, or 75% of the session. The first duration may be longer or shorter than the second duration. Optionally, in at least one mode of operation, the first duration is longer than the second duration. In this example, the ratio of the first duration to the second duration may be from 1.1:1 to 7:1, from 1.5:1 to 5:1, from 2:1 to 3:1, or approximately 2.5:1.

In a particular embodiment, the device is operable in a plurality of modes, and the ratios listed above apply to the first mode of operation. In the second mode of operation, the first duration may be longer or shorter than the second duration. Optionally, the second duration is longer than the first duration. Thus, one embodiment is a device which is configured such that in a first mode of operation, the first duration is longer than the second duration, but in the second mode of operation, the second duration is longer than the first duration. In one embodiment, in the second mode of operation, the ratio of the second duration to the first duration may be from 1.1:1 to 5:1, from 1.2 to 2:1 or from 1.3:1 to 1.4:1. In another embodiment, in the second mode of operation, the ratio of the second duration to the first duration may be from 2:1 to 12:1, from 2.5:1 to 11:1. In particular, the ratio may be from 3:1 to 4:1; alternatively, the ratio may be from 8:1 to 10:1. This embodiment may be particularly suitable for reducing the amount of condensate formed in the device during a session of use.

The inventors have identified that operating the first heating element at its maximum operating temperature for a greater proportion of the session of use may help in reducing the amount of condensate which collects in the device during use. This effect may be particularly noticeable in so-called “boost” modes of operation where the heating unit operates at a higher maximum operating temperature during a shorter session of use.

The maximum operating temperature 308 may be from approximately 200° C. to 300° C., or 210° C. to 290° C., or 220° C. to 280° C., or, 230° C. to 270° C., or 240° C. to 260° C.

FIG. 4 depicts a temperature profile 400 of a second heating element when present in an aerosol generating device, such as the second inductive heating element 124 shown in FIG. 1B, during an exemplary smoking session 402. Smoking session 402 corresponds to smoking session 302 shown in FIG. 3.

FIG. 4 depicts a temperature profile 400 of a second heating element when present in an aerosol generating device, such as the second inductive heating element 124 shown in FIG. 1B, during an exemplary session of use 402. Session of use 402 corresponds to session of use 302 shown in FIG. 3. The temperature profile 400 suitably refers to the temperature profile of the second inductive heating element 124 in any mode of operation of the heating assembly.

The session of use 402 begins when the device is activated 404 and energy is supplied to at least the first induction heating unit. In this example, the controller is configured not to supply energy to the second induction heating unit at the start of the session of use 402. Nevertheless, the temperature at the second induction heating element will likely rise somewhat due to thermal “bleed”—conduction, convection and/or radiation of thermal energy from the first heating element 114 to the second heating element 124.

At a first programmed time point 406 after the beginning of the session of use, the controller instructs energy to be supplied to the second heating unit 120 and the temperature of the second heating element 124 rises rapidly until the time point 408 at which a predetermined first operating temperature 410 is reached, then the controller controls the second heating unit 120 such that the second heating element 124 remains at substantially this temperature for a further period of time. The predetermined first operating temperature 410 may be lower than the maximum operating temperature 412 of the second heating element 124. In other embodiments (not shown), the first predetermined operating temperature is the maximum operating temperature; that is, the second heating element 124 is directly heated to its maximum operating temperature upon activation of the second heating unit 120.

In some embodiments, the predetermined first operating temperature 410 is from 150° C. to 200° C. The predetermined first operating temperature 410 may be greater than 150° C., 160° C., 170° C., 180° C., or 190° C. The predetermined first operating temperature 410 may be less than 200° C., 190° C., 180° C., 170° C., or 160° C. Optionally, the predetermined first operating temperature 410 is from 150° C. to 170° C. A lower first operating temperature 410 may help to reduce the amount of undesirable condensate which collects in the device.

In embodiments wherein the heating assembly is operable in a plurality of modes, the heating assembly may be configured such that the second heating element 124 rises to a first operating temperature 410, maintains the first operating temperature 410, then subsequently rises to the maximum operating temperature 412, in at least one mode. Optionally, the heating assembly is configured such that the second heating element 124 rises to a first operating temperature 410, maintains the first operating temperature 410, then subsequently rises to the maximum operating temperature 412 in all operable modes.

The first programmed time point 406 at which power is first supplied to the second heating unit 120 may be at least approximately 10 seconds, 20 seconds, 30 seconds, 40 seconds, 50 seconds, or 60 seconds after activation of the device 404. For embodiments wherein the heating assembly is operable in a plurality of modes, the first programmed time point 406 is at least approximately 10 seconds, 20 seconds, 30 seconds, 40 seconds, 50 seconds, 60 seconds, 70 seconds, or 80 seconds after activation of the device 404 in at least one mode. Optionally, the first programmed time point 406 is at least approximately 10 seconds, 20 seconds, 30 seconds, 40 seconds, 50 seconds, 60 seconds, 70 seconds, or 80 seconds after activation of the device 404 in all operable modes. The first programmed time point 406 may be the same in each mode, or it may differ between modes. Optionally, the first programmed time point 406 differs between the modes. In particular, the first programmed time point 406 may be at a later point in the session of use in the first mode than in the second mode.

In some embodiments, the heating assembly 100 may be configured such that the second induction unit 120 rises to the predetermined operating temperature 410 within 10 seconds, or 5 seconds, 4 seconds, 3 seconds or 2 seconds of the programmed time point 406 for increasing the temperature of the second induction heating element 124 to the first predetermined operating temperature 410. Put another way, the period 414 between the two time points 406, 408 may have a duration of 10 seconds or less, 5 seconds or less, 4 seconds or less, 3 seconds or less, or 2 seconds or less. Optionally, the period 414 has a duration of 2 seconds or less.

The second heating element 124 may be kept at the predetermined first operating temperature 410 for a predetermined period of time until a second programmed time point 416 at which the controller controls the second heating unit such that the second heating element 124 rises to its maximum operating temperature 412. At this second programmed time point 416 the temperature of the second heating element 124 rises rapidly until the time point 418 at which the maximum operating temperature 412 is reached. Then, the controller controls the second heating unit such that the second heating element 124 remains at substantially this temperature for a further period of time.

The second programmed time point 416 may be at least approximately 10 seconds, 20 seconds, 30 seconds, 40 seconds, 50 seconds, or 60 seconds after activation of the device 404.

In some embodiments, the heating assembly 100 may be configured such that the second induction element 124 rises from the first predetermined operating temperature 410 to the maximum operating temperature 412 within 10 seconds, or 5 seconds, 4 seconds, 3 seconds or 2 seconds of the programmed time point 416 for increasing the temperature of the second induction heating element 124 to the maximum operating temperature 412. Put another way, the period 420 between the two time points 416, 418 may have a duration of 10 seconds or less, 5 seconds or less, 4 seconds or less, 3 seconds or less, or 2 seconds or less. Optionally, the period 420 has a duration of 2 seconds or less.

The temperature of the second heating element in the period from timepoint 416 to timepoint 418 may rise at a rate of at least 50° C. per second, or 100° C. per second, or 150° C. per second.

In some embodiments the heating assembly 100 may be configured such that the second induction heating element 124 reaches the maximum operating temperature 412 after at least approximately 30 seconds, 40 seconds, 50 seconds, 60 seconds, 80 seconds, 100 seconds, or 120 seconds from activation of the device 404. Optionally, the heating assembly 100 is configured such that the second induction heating element 124 reaches the maximum operating temperature 412 after at least approximately 120 seconds after activation of the device 404.

In some embodiments, the heating assembly 100 may be configured such that the second induction heating element 124 reaches the maximum operating temperature 412 after at least approximately 10 seconds, 20 seconds, 30 seconds, 40 seconds, 50 seconds, 60 seconds, 80 seconds, 100 seconds, or 120 seconds from the first induction heating element 122 reaching its maximum operating temperature 308. Optionally the heating assembly 100 is configured such that the second induction heating element 124 reaches its maximum operating temperature 412 after at least approximately 120 seconds from the first induction heating element 122 reaching its maximum operating temperature 308. Put another way, with reference to FIGS. 3 and 4, time point 418 may be at least 120 seconds later than time point 310 during the smoking session 302, 402.

The second heating element 124 may be kept at its maximum operating temperature 412 for a predetermined period of time until the end of the smoking session 422, at which point the controller controls the heating assembly such that energy ceases to be supplied to all heating elements present in the aerosol generating device. Optionally, after the temperature of the second heating element 124 has reached an operating temperature (roughly around the first predetermined time point 406), the temperature of the second heating element 124 does not drop below the lowest operating temperature 424 of the second heating element 124 until the end of the smoking session 402.

In embodiments wherein the first heating element 122 drops from a maximum operating temperature 308 to a lower temperature later in the smoking session, the second heating element 124 may reach its maximum operating temperature 412 before the temperature drop of the first heating element 122, after the temperature drop of the first heating element 122, or concurrent with the temperature drop of the first heating element 122. In an embodiment, the second heating element 124 reaches its maximum operating temperature 412 before the first heating element 122 drops from its maximum operating temperature 308 to a lower temperature.

In some embodiments, the maximum operating temperature 308 of the first heating element 122 is substantially the same as that of the second heating element 124. In other embodiments the maximum operating temperatures 308, 412 of the first and second heating elements 122, 124 may differ. For example, the maximum operating temperature 308 of the first heating element 122 may be greater than that of the second heating element 124, or the maximum operating temperature 412 of the second heating element 124 may be greater than that of the first heating element 122. In one embodiment, the maximum operating temperature 308 of the first heating element 122 is greater than the maximum operating temperature 412 of the second heating element 124. In another embodiment, the maximum operating temperature 308 of the first heating element 122 is substantially the same as that of the second heating element 124.

For periods during which a heating element remains at a substantially constant temperature, there may be minor fluctuations in the temperature around the target temperature defined by the controller. In some embodiments, the fluctuation is less than approximately ±10° C., or ±5° C., or ±4° C., or ±3° C., or ±2° C., or ±1° C. Optionally the fluctuation is less than approximately ±3° C. for at least the first heating element, at least the second heating element, or both the first heating element and second element.

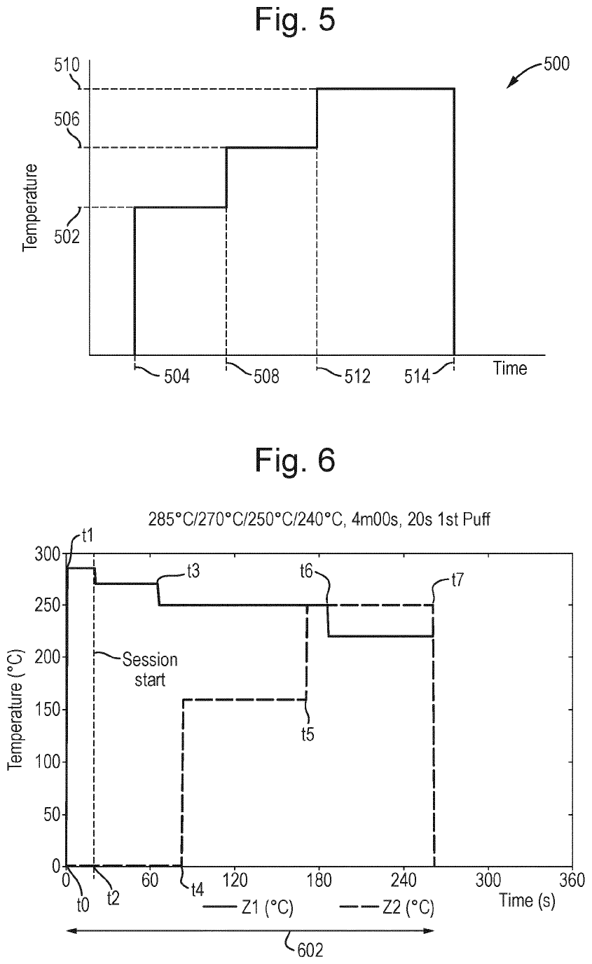

FIGS. 3 and 4 discussed hereinabove reflect the measured or observed temperature profile of heating unit(s) present in the device 100. FIG. 5 reflects a programmed heating profile of any heating unit(s) present in the device 100. Any programmed heating profile of any heating unit present in the heating assembly of the present device may be depicted by the general programmed heating profile as shown in FIG. 5.

A programmed heating profile 500 includes a first temperature, temperature A 502. Temperature A 502 is the first temperature which the heating unit is programmed to reach during a given session of use, at timepoint A 504. timepoint A 504 may conveniently be defined in terms of the number of seconds elapsed from the start of a session of use, i.e. from the point at which power is first supplied to at least one heating unit present in the heating assembly.

Optionally, a programmed heating profile 500 may include a second temperature, temperature B 506. Temperature B 506 is a temperature different to temperature A 502. In some embodiments, the device is programmed to reach temperature B 506 during a given session of use at timepoint B 508. Timepoint B 508 occurs temporally after timepoint A 504.

From timepoint A 504 to timepoint B 508, the device is programmed to have substantially the same temperature, temperature A 502. However, in some embodiments, there may be variation about temperature A 502 in this period. For example, the heating unit may have a temperature within 10° C. of temperature A 502 during this period, optionally within 5° C. of temperature A 502 during this period. Such profiles are still considered to correspond to the profile shown generally in FIG. 5. In other embodiments, there is substantially no variation from temperature A 502 during this period.

Even though FIG. 5 depicts temperature B 506 being higher than temperature A 502, the programmed heating profiles of the present disclosure are not so limited: temperature B 506 may be higher or lower than temperature A 502 for any given heating profile.

Optionally, a programmed heating profile 500 includes a second temperature, Temperature B 506.

Optionally, a programmed heating profile 500 may include a third temperature, temperature C 510. Temperature C 510 is a temperature different to temperature B. In some embodiments, the device is programmed to reach to temperature C 510 during a given session of use at timepoint C 512. Timepoint C 512 occurs temporally after timepoint B 508 and thus timepoint A 502.

Temperature C 510 may or may not be the same temperature as temperature A 502.

Even though FIG. 5 depicts temperature C 510 being higher than temperature B 506 and temperature A 502, the programmed temperature profiles of the present disclosure are not so limited: temperature C 510 may be higher or lower than temperature A 502 for any given heating profile; temperature C 510 may be higher or lower than temperature B 506 for any given heating profile.

The programmed heating profile 500 includes a final timepoint 514, the point at which energy stops being supplied to the heating unit for the rest of the session of use. It may be that the final timepoint 514 is concurrent with the end of the session of use.

Surprisingly, it has been found that the temperatures 502, 506, 510 and timepoints 504, 508, 512, 514 of the programmed heating profile of the heating unit(s) may be modulated to reduce the accumulation of condensation in a device 100. In particular, configuring the device such that timepoint B 508 occurs after 50% of the session of use has elapsed, optionally after 75% of the session of use has elapsed, may reduce the amount of condensate which collects in the device in use.

In embodiments wherein the heating assembly comprises at least two heating units, the heating assembly may be configured such that the first and second heating units have substantially the same maximum operating temperature. The inventors have identified that this configuration may also reduce the accumulation of condensation in the device.

Table 1 lists some parameters for a variety of possible programmed heating profiles for heating units in the present device. Suitable ranges of temperatures for Temperature A 502 and Temperature B 504 are given; various heating units and modes of operation associated with each profile are also given.

In some embodiments, the heating assembly is configured such that at least one of the heating units present has a programmed heating profile as depicted in FIG. 5 having a temperature A 502 and optionally a temperature B 504, wherein temperature A 502 and temperature B 506 are selected from the ranges given in Table 1.

In particular embodiments, the device is configured such that at least two heating units in the heating assembly have programmed heating profiles selected from Table 1. Further, in some embodiments, the device is configured such that each heating unit present in the heating assembly has a programmed heating profile selected from Table 1.

In Table 1 where values are given in the temperature B column for any given profile number, that profile optionally includes temperature B 506 falling within that range. Where a cell contains “-” in the temperature B column, that profile optionally does not include temperature B 506 or temperature C 510.

Each heating profile may suitably be applied to any heating unit present in the heating assembly for any mode of operation. Optionally, though, profiles specifying “1” in the “Heater” column are applied to the first heating unit in the heating assembly; profiles specifying “2” are optionally applied to the second heating unit in the heating assembly, where present.

Similarly, profiles specifying “1” in the “Mode” column are optionally applied to a heating unit in the heating assembly for a first mode of operation; profiles specifying “2” are optionally applied to a heating unit in the heating assembly for a second mode of operation, conveniently referred to as a “boost” mode.

In particular embodiments, the heating assembly comprises two heating units, the heating assembly being configured such that in at least one mode of operation, the heating units have programmed heating profiles selected from a pair of heating profiles banded by double lines in Table 1.

In a further embodiment, the heating assembly is configured to operate in at least a first mode of operation and a second mode of operation, wherein in the first mode of operation the heating units have programmed heating profiles selected from a pair of heating profiles banded by double lines in indicated as suitable for use in a first mode of operation, and in the second mode of operation the heating units have programmed heating profiles selected from a pair of heating profiles banded by double lines in Table 1 indicated as suitable for use in a second mode of operation.

TABLE 1

| Profile | Temp. | Temp. | Heating | |
|---|---|---|---|---|
| No. | A (° C.) | B (° C.) | unit | Mode |
| 1 | 240-295 | 210-260 | 1 | 1 |
| 2 | 150-170 | 240-260 | 2 | 1 |
| 3 | 250-270 | 220-240 | 1 | 2 |
| 4 | 130-150 | 250-280 | 2 | 2 |
| 5 | 270-290 | 210-230 | 1 | 2 |
| 6 | 150-170 | 250-270 | 2 | 2 |

Any of the programmed temperature profiles 1 to 6 may or may not include a temperature C 510.

In some embodiments, the heating assembly is configured such that at least one of the heating units present has a programmed heating profile as depicted in FIG. 5 having a temperature A 502 and optionally a temperature B 504 occurring at timepoint A 504 and timepoint B 508 respectively, and a final timepoint 514, the timepoints being selected from Table 2.

In particular embodiments, the device is configured such that at least two heating units in the heating assembly have programmed heating profiles selected from Table 2. Further, in some embodiments, the heating assembly is configured such that each heating unit present in the heating assembly has a programmed heating profile selected from Table 2.

In Table 2, where values are given in the time B column for any given profile number, that profile optionally includes timepoint B 506 falling within that range. Where a cell contains “-” in the time B column, that profile optionally does not include timepoint B 508 or timepoint C 510.

TABLE 2

| Profile | Time | Time | End |
|---|---|---|---|
| No. | A (s) | B (s) | Time (s) |
| 1 | 0-20 | 130-150 | 250-270 |
| 2 | 80-170 | 170-260 | 250-270 |
| 3 | 0-140 | 140-90 | 215-235 |
| 4 | 60-100 | 100-130 | 215-235 |
| 5 | 0-85 | 85-195 | 185-205 |
| 6 | 64-79 | 79-85 | 185-205 |

In embodiments, the numbered profiles of Table 1 correspond to those of Table 2, such that a heating unit is programmed to reach the temperatures recited in Table 1 at the timepoints recited in Table 2.

### EXAMPLES

Six programmed heating profiles were assessed and are summarised in Table 3. The profiles were tested on an aerosol generating device according to an example wherein the heating assembly contained two heating units. The heating units were arranged such that the first heating unit was disposed closer to the mouth end of the heating assembly than the second heating unit. The assembly was configured such that the heating units had different programmed heating profiles; the heating profiles of the heating assembly were paired as the profiles are paired within the double lines shown in Table 3.

TABLE 3

| Profile | Temp. | Time | Temp. | Time | Final | | |
|---|---|---|---|---|---|---|---|
| No. | A (° C.) | A (s) | B (° C.) | B (s) | time (s) | Heater | Mode |
| 1 | 285 | 0 | 270 | 65 | 260 | Heater 1 | First |
| 2 | 160 | 82 | 250 | 170 | 260 | Heater 2 | First |
| 3 | 260 | 0 | 230 | 140 | 225 | Heater 1 | Second |
| 4 | 160 | 60 | 260 | 75 | 225 | Heater 2 | Second |
| 5 | 280 | 0 | 220 | 85 | 195 | Heater 1 | Second |
| 6 | 160 | 82 | 260 | 170 | 195 | Heater 2 | Second |

The inventors have identified that the above six profiles are of particular interest with regards minimising the amount of undesirable condensation observed inside the device.

Particular profiles of Table 3 will now be described in detail.

### Mode 1 (Base)

### Example 1

Profile Name BASE 285/240, 4m00s
Time to 1st Puff 20 s

| Cumulative | Profile | | Zone | Zone |
|---|---|---|---|---|
| Time(s) | Steps | Step(s) | 1 Temp | 2 Temp |
| 20 | 1 | 20 | 285 | 0 |
| 65 | 2 | 45 | 270 | 0 |
| 82 | 3 | 17 | 250 | 0 |
| 170 | 4 | 88 | 250 | 160 |
| 185 | 5 | 15 | 250 | 250 |
| 260 | 6 | 75 | 220 | 250 |

An aerosol generating device containing the heating assembly 100 shown in FIG. 1 was monitored during a session of use in a first mode of operation. FIG. 6 shows the programmed heating profile of the first heating unit 110 (solid line) and the second heating unit 120 (dashed line). The programmed heating profiles correspond to profiles 1 and 2 respectively from Table 3.

The heating assembly 100 was programmed such that the first heating unit 110 should reach a maximum operating temperature of 285° C. as quickly as possible. The heating assembly 100 was programmed such that the first heating unit 110 would remain at a temperature of 285° C. for the first 20 seconds of the session of use, then drop to a temperature of 270° C. before dropping further to 250° C. with a yet further drop to 220° C.

The heating assembly 100 was programmed such that the second heating unit 120 would reach an operating temperature of 160° C. approximately 82 seconds after the start of the session of use. The heating assembly 100 was programmed such that the second heating unit 120 would subsequently rise to a maximum heating temperature of 250° C. approximately 170 seconds after the start of the session of use, and remain at that temperature until the end of the session of use, 260 seconds after the start of the session of use.

It is unknown to provide a temperature profile for the first heating unit 110 which progressively reduces the temperature in four stages. The inventors have identified that that this temperature profile in combination with the temperature profile of the second heating unit 120 is particularly effective at minimising the amount of undesirable condensation observed inside the device.

### Mode 2 (Boost)

### Example 2

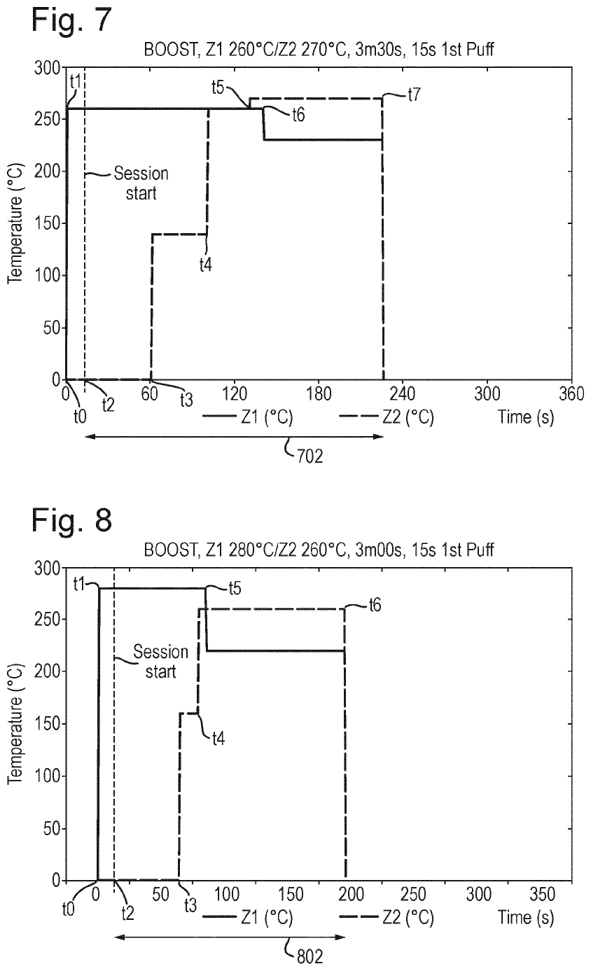

An aerosol generating device containing the heating assembly 100 shown in FIG. 1 was monitored during another session of use in a first mode of operation. FIG. 7 shows the programmed heating profile of the first heating unit 110 (solid line) and the second heating unit 120 (dashed line). The programmed heating profiles correspond to profiles 3 and 4 from Table 3 respectively.

Profile Name Alt. 3 260/270, 3m30s
Time to 1st Puff 15 s

| Cumulative | Profile | | Zone | Zone |
|---|---|---|---|---|
| Time (s) | Steps | Step (s) | 1 Temp | 2 Temp |
| 60 | 1 | 60 | 260 | 0 |
| 100 | 2 | 40 | 260 | 140 |
| 130 | 3 | 30 | 260 | 260 |
| 140 | 4 | 10 | 260 | 270 |
| 225 | 5 | 85 | 230 | 270 |

The heating assembly 100 was programmed such that the first heating unit 110 should reach a maximum operating temperature of 260° C. as quickly as possible. The heating assembly 100 was programmed such that the first heating unit 110 would remain at a temperature of 260° C. for the first 140 seconds of the session of use, then drop to a temperature of 230° C.

The heating assembly 100 was programmed such that the second heating unit 120 would reach an operating temperature of 140° C. approximately 60 seconds after the start of the session of use. The heating assembly 100 was programmed such that the second heating unit 120 would subsequently rise to a heating temperature of 260° C. approximately 100 seconds after the start of the session of use, and then increase again to a maximum operating temperature of 270° C. and remain at that temperature until the end of the session of use, 225 seconds after the start of the session of use.

It is unknown to provide a temperature profile for the first heating unit 110 and the second heating unit 120 wherein in the second half of the session 802 the temperature (270° C.) of the second heating unit 120 exceeds the temperature (260° C. then 230° C.) of the first heating unit 110. The inventors have identified that that this combined temperature profile is particularly effective at minimising the amount of undesirable condensation observed inside the device.

### Example 3

An aerosol generating device containing the heating assembly 100 shown in FIG. 1 was monitored during another session of use in a first mode of operation. FIG. 8 shows the programmed heating profile of the first heating unit 110 (solid line) and the second heating unit 120 (dashed line). The programmed heating profiles correspond to profiles 5 and 6 from Table 3 respectively.

Profile Name Express BOOST Option E 280/260, 3m00s
Time to 1st Puff 15 s

| Cumulative | Profile | | Zone | Zone |
|---|---|---|---|---|
| Time(s) | Steps | Step(s) | 1 Temp | 2 Temp |
| 64 | 1 | 64 | 280 | 0 |
| 79 | 2 | 15 | 280 | 160 |
| 85 | 3 | 6 | 280 | 260 |
| 195 | 4 | 110 | 220 | 260 |

The heating assembly 100 was programmed such that the first heating unit 110 should reach a maximum operating temperature of 280° C. as quickly as possible. The heating assembly 100 was programmed such that the first heating unit 110 would remain at a temperature of 280° C. for the first 85 seconds of the session of use, then drop to a temperature of 220°.

The heating assembly 100 was programmed such that the second heating unit 120 would reach an operating temperature of 160° C. approximately 64 seconds after the start of the session of use. The heating assembly 100 was programmed such that the second heating unit 120 would subsequently rise to a maximum heating temperature of 260° C. approximately 79 seconds after the start of the session of use and remain at that temperature until the end of the session of use, 195 seconds after the start of the session of use.

It is unknown to provide a temperature profile for the first heating unit 110 and the second heating unit 120 wherein in the second half of the session 802 the temperature (270° C.) of the second heating unit 120 exceeds the temperature (260° C. then 230° C.) of the first heating unit 110. The inventors have identified that this combined temperature profile is particularly effective at minimising the amount of undesirable condensation observed inside the device.

### Example 4

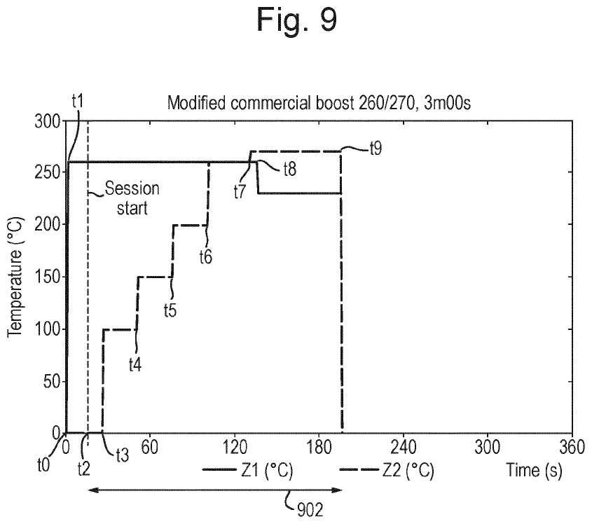

An aerosol generating device containing the heating assembly 100 shown in FIG. 1 was monitored during another session of use in a first mode of operation. FIG. 9 shows the programmed heating profile of the first heating unit 110 (solid line) and the second heating unit 120 (dashed line).

Profile Name Modified Commercial BOOST 260/270, 3m00s
Time to 1st Puff 15-20 s

| Cumulative | Profile | | Zone | Zone |
|---|---|---|---|---|
| Time(s) | Steps | Step(s) | 1 Temp | 2 Temp |
| 25 | 1 | 25 | 260 | 0 |
| 50 | 2 | 25 | 260 | 100 |
| 75 | 3 | 25 | 260 | 150 |
| 100 | 4 | 25 | 260 | 200 |
| 130 | 5 | 30 | 260 | 260 |
| 135 | 6 | 5 | 260 | 270 |
| 195 | 7 | 60 | 230 | 270 |

The heating assembly 100 was programmed such that the first heating unit 110 should reach a maximum operating temperature T1 of approximately 260° C. as quickly as possible. The heating assembly 100 was programmed such that the first heating unit 110 would remain at a temperature T1 of 260° C. for the first 135 seconds of the session of use, then drop to a temperature T7 of approximately 230° C. for the rest of the session.

The heating assembly 100 was programmed such that the second heating unit 120 was initially at ambient temperature T2 for the first 25 seconds after the start of the session of use. The heating assembly 100 was programmed so that the second heating unit would then reach an operating temperature T3 of 100° C. at a time t3 approximately 25 seconds after the start of the session of use. The heating assembly 100 was programmed such that the second heating unit 120 would subsequently rise to a heating temperature T4 of 150° C. at a time t4 approximately 50 seconds after the start of the session of use. The heating assembly 100 was programmed such that the second heating unit 120 would subsequently rise to a heating temperature T5 of 200° C. at a time t5 approximately 75 seconds after the start of the session of use. The heating assembly 100 was further programmed such that the second heating unit 120 would subsequently rise at time t6 to a heating temperature T1 of 260° C. approximately 100 seconds after the start of the session of use. The temperature of the first and second heating units 110,120 are therefore optionally substantially the same (optionally 260° C.) for a period of time which may be approximately 30 seconds.

An important aspect of the embodiment is that at a time t7 (optionally 130 seconds after start of the session of use) the heating assembly 100 may be programmed to increase the desired operating temperature of the second heating unit 120 to a temperature T6 which is above the maximum operating temperature T1 of the first heating unit 110. For example, according to an embodiment the temperature T6 of the second heating unit 120 may be set to 270° C. which may be 10° C. hotter than the maximum operating or heating temperature T1 of the first heating unit 110 (260° C.).

Other embodiments are contemplated wherein the temperature T6 of the second heating unit 120 may be 0-10° C., 10-20° C., 20-30° C., 30-40° C., 40-50° C. or more than 50° C. hotter than the maximum operating or heating temperature T1 of the first heating unit 110.

According to the embodiment the heating assembly 100 may be arranged to maintain the temperature of the second heating unit 120 at the maximum operating temperature T6 until the end of the session of use which may be 195 seconds after the start of the session of use.

According to the embodiment, the heating assembly 100 may be arranged to drop the temperature of the first heating unit 110 to a lower operating temperature T7 (optionally 230° C.) at a time t8 which may be 135 seconds after the start of the session of use. Once the temperature of the first heating unit 110 is reduced to the lower operating temperature of T7 (optionally 230° C.) the temperature may be maintained at that level until the end of the session of use which may be 195 seconds after the start of the session of use.

It is unknown to provide a temperature profile for the first heating unit 110 and the second heating unit 120 wherein in the second half of the session 902 the (maximum) operating or heating temperature (270° C.) of the second heating unit 120 exceeds the (maximum) operating or heating temperature (260° C.) of the first heating unit 110. According to an embodiment the maximum operating or heating temperature of the second heating unit 120 may be set to be 0-10° C., 10-20° C., 20-30° C., 30-40° C. or 40-50° C. higher than the maximum operating or heating temperature of the first heating unit 110. The inventors have identified that that this combined temperature profile is particularly effective at minimising the amount of undesirable condensation observed inside the device. The inventors have also identified that that this combined temperature profile is particularly effective in improving the flavour and associated taste experience of the user.

The heating profile according to the embodiment shown in FIG. 9 is similar to the heating profile shown and described above with reference to FIG. 7. However, whereas according to the embodiment shown and described with reference to FIG. 7 there are two profile steps (t0-t3 and t3-t4) before the first heating unit 110 and the second heating until 120 reach substantially the same operating or heating temperature, according to the present embodiment as shown and described with reference to FIG. 9 there are more than two profile steps before the first heating unit 110 and the second heating until 120 reach substantially the same operating or heating temperature.

According to an embodiment there may be three, four, five, six, seven, eight, nine, ten or more than ten profile steps before the first heating unit 110 and the second heating until 120 reach substantially the same operating or heating temperature.

According to an embodiment as shown in FIG. 9 there may be four profile steps (t043, t3-t4, t4-t5, t5-t6) before the first heating unit 110 and the second heating until 120 reach substantially the same operating or heating temperature.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An aerosol generating device for generating aerosol from an aerosol generating material comprising:
a first heating unit arranged to heat, but not burn, the aerosol generating material in use;
a second heating unit arranged to heat, but not burn, the aerosol generating material in use; and
a controller arranged to control the first heating unit and the second heating unit wherein during a session the controller is arranged to set the first heating unit:
(i) a target operating temperature T1 during a time period t1-t2;
(ii) a target operating temperature T2 during a time period t2-t3;
(iii) a target operating temperature T3 during a time period t3-t6; and
(iv) a target operating temperature T4 during a time period t6-t7;
wherein temperature T1>T2>T3>T4 and time t0<t1<t2<t3<t4<t5<t6<t7.

2. The aerosol generating device of claim 1, wherein during the session the controller is further arranged to set the second heating unit:
(i) a target operating temperature T5 during a time period t0-t4;
(ii) a target operating temperature T6 during a time period t4-t5; and
(iii) a target operating temperature T7 during a time period t5-t7;
wherein temperature T7>T6>T5.

3. The aerosol generating device of claim 1, wherein: (i) t0=0 s and comprises the start of the session; (ii) t1=2±2 s; (iii) t2=20±10 s and comprises time of first puff; (iv) t3=65±10 s; (v) t4=82±10 s; (vi) t5=170±10 s; (vii) t6=185±10 s; and (viii) t7=260±10 s and comprises the end of the session.

4. The aerosol generating device of claim 1, wherein: (i) T1=285° C.±10° C.; (ii) T2=270° C.±10° C.; (iii) T3=250° C.±10° C.; (iv) T4=220° C.±10° C.; (v) T5=ambient or <100° C.; (vi) T6=160° C.±10° C.; and (vii) T7=250° C.±10° C.

5. An aerosol generating device for generating aerosol from an aerosol generating material comprising:
a first heating unit arranged to heat, but not burn, the aerosol generating material in use;
a second heating unit arranged to heat, but not burn, the aerosol generating material in use; and
a controller arranged to control the first heating unit and the second heating unit wherein during a session the controller is arranged to set the second heating unit:
(i) a target operating temperature T1 during a time period t0-t3;
(ii) a target operating temperature T2 during a time period t3-t4;
(iii) a target operating temperature T3 during a time period t4-t5; and
(iv) a target operating temperature T4 during a time period t5-t7;
wherein temperature T4>T3>T2>T1 and time t0<t1<t2<t3<t4<t5<t6<t7.

6. The aerosol generating device of claim 5, wherein during the session the controller is further arranged to set the first heating unit:
(i) a target operating temperature T5 during a time period t1-t6; and
(ii) a target operating temperature T6 during a time period t6-t7;
wherein temperature T4>T5=T3>T6>T2>T1.

7. The aerosol generating device of claim 5, wherein: (i) t0=0 s and comprises the start of the session; (ii) t1=2±2 s; (iii) t2=15±10 s and comprises time of first puff; (iv) t3=60±10 s; (v) t4=100±10 s; (vi) t5=130±10 s; (vii) t6=140±10 s; and (viii) t7=225±10 s and comprises the end of the session.

8. The aerosol generating device of claim 5, wherein: (i) T1=ambient or <100° C.; (ii) T2=140° C.±10° C.; (iii) T3=260° C.±10° C.; (iv) T4=270° C.±10° C.; (v) T5=260° C.±10° C.; and (vi) T6=230° C.±10° C.

9. An aerosol generating device for generating aerosol from an aerosol generating material comprising:
a first heating unit arranged to heat, but not burn, the aerosol generating material in use;
a second heating unit arranged to heat, but not burn, the aerosol generating material in use; and
a controller arranged to control the first heating unit and the second heating unit wherein during a session the controller is arranged to set the first heating unit:
(i) a target operating temperature T1 during a time period t0-t5;
(ii) a target operating temperature T2 during a time period t5-t6;
and wherein during the session the controller is further arranged to set the second heating unit:
(iii) a target operating temperature T3 during a time period t0-t3;
(iv) a target operating temperature T4 during a time period t3-t4; and
(iv) a target operating temperature T5 during a time period t4-t6;
wherein temperature T1>T5>T2>T4>T3 and time t0<t1<t2<t3<t4<t5<t6.

10. The aerosol generating device of claim 9, wherein: (i) t0=0 s and comprises the start of the session; (ii) t1=2±2 s; (iii) t2=15±10 s and comprises time of first puff; (iv) t3=64±10 s; (v) t4=79±10 s; (vi) t5=85±10 s; and (vii) t6=195±10 s and comprises the end of the session.

11. The aerosol generating device of claim 9, wherein: (i) T1=280° C.±10° C.; (ii) T2=220° C.±10° C.; (iii) T3=ambient or <100° C.; (iv) T4=160° C.±10° C.; and (v) T5=260° C.±10° C.

12. The aerosol generating device of claim 9, wherein the aerosol generating device has a mouth end and a distal end, and wherein the first heating unit is arranged closer to the mouth end of the aerosol generating device than the second heating unit.

13. The aerosol generating device of claim 9, wherein at least one of:
(i) the first heating unit comprises an induction heating unit and the second heating unit comprises an induction heating unit;
(ii) the first heating unit comprises an induction heating unit and the second heating unit comprises a resistive or non-induction heating unit;
(iii) the first heating unit comprises a resistive or non-induction heating unit and the second heating unit comprises an induction heating unit; or
(iv) the first heating unit comprises a resistive or non-induction heating unit and the second heating unit comprises a resistive or non-induction heating unit.

14. The aerosol generating device of claim 9, wherein the first heating unit is controllable independent from the second heating unit.

15. The aerosol generating device of claim 9, wherein the aerosol generating device is configured such that the first heating unit and the second heating unit have temperature profiles which differ from each other in use.

16. The aerosol generating device of claim 9, wherein the device is configured such that in use the second unit rises from a first operating temperature to a maximum operating temperature which is higher than the first operating temperature at a rate of at least 50° C. per second.

17. The aerosol generating device of claim 9, wherein the device is configured such that the first heating unit reaches a maximum operating temperature within 2 seconds of activating the aerosol generating device.

18. The aerosol generating device of claim 9, wherein the aerosol generating device is configured to generate aerosol from a non-liquid aerosol generating material.

19. The aerosol generating device of claim 18, wherein the non-liquid aerosol generating material comprises tobacco.

20. The aerosol generating device of claim 19, wherein the aerosol generating device is a tobacco heating product.

21. The aerosol generating device of claim 9, further comprising an indicator for indicating to a user that the device is ready for use within 20 seconds of activating the device.

22. The aerosol generating device of claim 9, wherein the maximum operating temperature of the first heating unit is in the range 200-300° C. and/or the maximum operating temperature of the second heating unit is in the range 200-300° C.

23. The aerosol generating device of claim 9, further comprising one or more additional heating units.

24-49. (canceled)
